(19) United States
(12) Patent Application Publication
(10) Pub. No.: US 2024/0361037 A1
(43) Pub. Date: Oct. 31, 2024

(54) HUMIDIFIER

(71) Applicant: LG ELECTRONICS INC., Seoul (KR)

(72) Inventors: Myungjin KU, Seoul (KR); Geunnam LIM, Seoul (KR); Donggun LEE, Seoul (KR); Junehee KIM, Seoul (KR)

(21) Appl. No.: 18/647,399

(22) Filed: Apr. 26, 2024

(30) Foreign Application Priority Data
Apr. 27, 2023 (KR) 10-2023-0055143

(51) Int. Cl. F24F 13/20; F24F 6/00; F24F 6/02; F24F 6/12

(52) U.S. Cl. CPC F24F 13/20; F24F 2006/008; F24F 6/025; F24F 6/12; F24F 2221/02

(57) ABSTRACT

A humidifier may include a case; a humidifying device which is disposed inside the case, and generates humidified air; and a light source which is disposed inside the case, and emits light, wherein the case includes an inner shell which is disposed above the humidifying device, and in which a first discharge flow path through which the humidified air flows is formed, wherein the light source is disposed outside the inner shell.

### CROSS-REFERENCE TO RELATED APPLICATION(S)

This application claims priority under 35 U.S.C. § 119 to Korean Application No. 10-2023-0055143 filed, filed in Korea on Apr. 27, 2023, whose entire disclosure(s) is/are hereby incorporated by reference.

### BACKGROUND

### 1. Field

A humidifier is disclosed herein.

### 2. Background

A humidifier is a device that vaporizes water and emits humidified air with a relatively high moisture content. A humidifier can generate humidified air by vaporizing water through various processes, such as natural evaporation, heated evaporation, or ultrasonic vibration.

An ‘upward discharge type large-capacity humidifier’ discussed in Korean Patent No. 10-2500340 may include a water tank for storing water; a main body that is disposed below the water tank and that has a discharge hole formed in an upper side; a vibrator disposed on the inner bottom surface of the main body to generate mist; and a lamp that is centrally disposed of the bottom surface of the main body and that emits light, an outer circumferential surface of the main body including a light transmitting plate for outputting light. However, this humidifier positions a lamp in the middle of a water tank where water is stored, and the lamp may be damaged from water spilled from the water tank. In addition, since the lamp is exposed to a space through which humidified air flows, condensation from the humidified air may form on the lamp, and the lamp may be damaged by the condensation. In addition, a short circuit may occur when the lamp is exposed to water, thereby posing a potential safety risk to a user and causing potential damage to the humidifier.

The above reference is incorporated by reference herein where appropriate for appropriate teachings of additional or alternative details, features and/or technical background.

### BRIEF DESCRIPTION OF THE DRAWINGS

Embodiments will be described in detail with reference to the following drawings in which like reference numerals refer to like elements, and wherein:

FIG. 1 is a perspective view of a humidifier according to an embodiment;

FIG. 2 is a schematic diagram of a humidifier according to an embodiment;

FIG. 3 is a longitudinal cross-sectional view of a humidifier according to an embodiment;

FIG. 4 is a longitudinal cross-sectional view of a blowing device included in a humidifier in certain implementations;

FIG. 5 is a diagram showing a humidifying device and a flow path unit included in a humidifier in certain implementations;

FIG. 6 is a longitudinal cross-sectional view of a humidifying device included in a humidifier in certain implementations;

FIG. 7 is a perspective view of a flow path unit included in a humidifier in certain implementations;

FIG. 8 is an exploded view of a coupling of flow path unit included in a humidifier in certain implementations;

FIG. 9 is a perspective view of a water tank and a water tank cover included in a humidifier in certain implementations;

FIG. 10 is a cross-sectional perspective view of FIG. 9;

FIG. 11 is a perspective view of a water tank housing included in a humidifier in certain implementations;

FIG. 12 is a cross-sectional perspective view of FIG. 11;

FIG. 13 is a perspective view of an inner shell included in a humidifier in certain implementations;

FIG. 14 is a cross-sectional perspective view of FIG. 13;

FIG. 15 is a perspective view of an outer shell included in a humidifier in certain implementations;

FIG. 16 is a cross-sectional perspective view of FIG. 15;

FIG. 17 is a perspective view of a middle tray included in a humidifier in certain implementations;

FIG. 18 is a cross-sectional perspective view of FIG. 17;

FIG. 19 is a cross-sectional view of a middle tray included in a humidifier in certain implementations;

FIG. 20 is a plan view of a portion of a middle tray included in a humidifier in certain implementations;

FIG. 21 is a coupling perspective view of a water tank housing, an inner shell, and a middle tray included in a humidifier in certain implementations;

FIG. 22 is a cross-sectional perspective view of FIG. 21;

FIG. 23 is an enlarged view of S1 in FIG. 21;

FIG. 24 is a cross-sectional view of a portion of a humidifier according to an embodiment; and

FIG. 25 is an enlarged cross-sectional view of a portion of a humidifier according to an embodiment.

### DETAILED DESCRIPTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected with” another element, there may be intervening elements present. In contrast, it will be understood that when an element is referred to as being “directly connected with” another element, there are no intervening elements present. A singular representation may include a plural representation unless context clearly indicates otherwise.

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof. The direction indications of up (U), down (D), left (Le), right (Ri), front (F), rear (R), and outside (O) shown in the drawing are only for convenience of explanation, and the technical concept disclosed in this specification is not limited thereto.

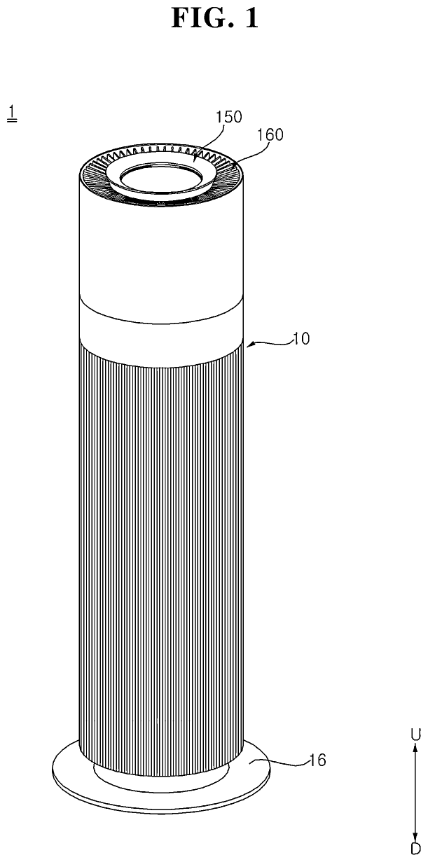

Referring to FIG. 1, a humidifier 1 in certain implementations may include a case 10, a stand 16, a discharge grill 160, and a water tank cover 150. The case 10 may form at least a portion of an outer shape of the humidifier 1. The case 10 may extend long in the up-down direction. For example, the case 10 may have a cylindrical shape extending long in the up-down direction. The case 10 may include an internal space. A humidifying device 200, which will be described later, to generate humidified air may be disposed in the internal space of the case 10.

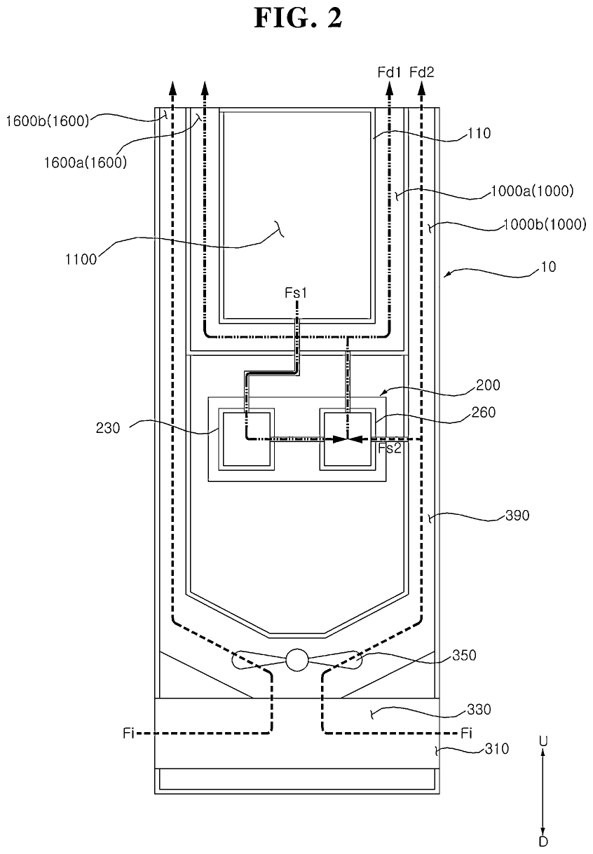

The case 10 may include a suction hole, such as suction hole 310 depicted in FIG. 2. The suction hole may be a through hole formed in the case 10. The suction hole may be formed in a side surface of the case 10. The suction hole may be formed in a circumferential surface of the case 10. For example, the suction hole may be a through hole formed in a circumferential surface of the case 10. The case 10 may include a discharge hole, such as discharge hole 1600 in FIG. 2. The humidified air generated within humidifier 1 may be supplied to the indoor space through a discharge hole of the case 10. The discharge hole may be formed above the case 10. The upper side of the case 10 may be open. The discharge hole may be an opening formed above the case 10. For example, the discharge hole may be a substantially annular or other shaped discharge hole opened in the upper surface of the cylindrical case 10. The indoor air flowing in through the suction hole may be discharged through the discharge hole together with moisture as humidified air.

The humidifier 1 may include a stand 16 that supports the case 10. The stand 16 may be disposed below the case 10. The stand 16 may be fixed to the case 10. The stand 16 can improve the stability and help to prevent the case 10 from falling. The diameter of the stand 16 may be larger than the diameter of the case 10. The outer circumference of the stand 16 may be located outside the peripheral wall of the case 10 in the horizontal direction.

The discharge grill 160 may be disposed in or above the discharge hole. The discharge grill 160 may be disposed in the open upper side of the case 10. The discharge grill 160 may be disposed in the discharge hole. The discharge grill 160 may form a portion of the upper surface of the case 10. Humidified air may pass through the discharge grill 160 and be supplied to the indoor space.

The water tank cover 150 may be disposed on the open upper side of the case 10. The water tank cover 150 may be disposed at the center of the discharge grill 160. The discharge grill 160 may be disposed radially to the outside of the water tank cover 150. The water tank cover 150 may cover the water tank 110 described later. The water tank cover 150 may be a lid of the water tank 110. The water tank cover 150 may be removably attached to the discharge grill 160. For example, a user may supply water to the water tank 110 by separating the water tank cover 150 from the discharge grill 160. After supplying water, a user may couple the water tank cover 150 to the discharge grill 160 to reseal the water tank 110.

Referring to FIG. 2, the humidifier 1 in certain implementations may include a case 10, a water tank 110, a humidifying device 200, and a blowing fan 350. The indoor air may be flow into the humidifier 1 through a suction hole 310 formed in the case 10 (Fi). The suction hole 310 may be formed in the lower portion of the case 10. The air flowing into the inside of the case 10 may flow through the flow path formed therein (Fi). The air flowing inside the case 10 may be discharged back to the indoor space through a discharge hole 1600 formed in the upper side of case 10 (Fi). At this time, the humidity of the discharged air may be higher than the humidity of the sucked air.

The water tank 110 may store water. The water tank 110 may include a water storage space 1100 in which water is stored. The water stored in the water storage space 1100 may be supplied to the humidifying device 200 (Fs1). The humidifying device 200 can generate humidified air using supplied water. The humidifying device 200 may generate humidified air. Humidified air may include mist and/or water vapor. That is, humidified air may refer to air including mist (e.g., water droplets) and/or water vapor (e.g., evaporated water). The humidity of humidified air may be relatively higher than the humidity of indoor air.

The humidifying device 200 may include a heating water tank 230. Water supplied from the water tank 110 may flow into the heating water tank 230 (Fs1). The heating water tank 230 may heat the water supplied from the water tank 110. The heating water tank 230 may evaporate and/or sterilize the supplied water by heating it.

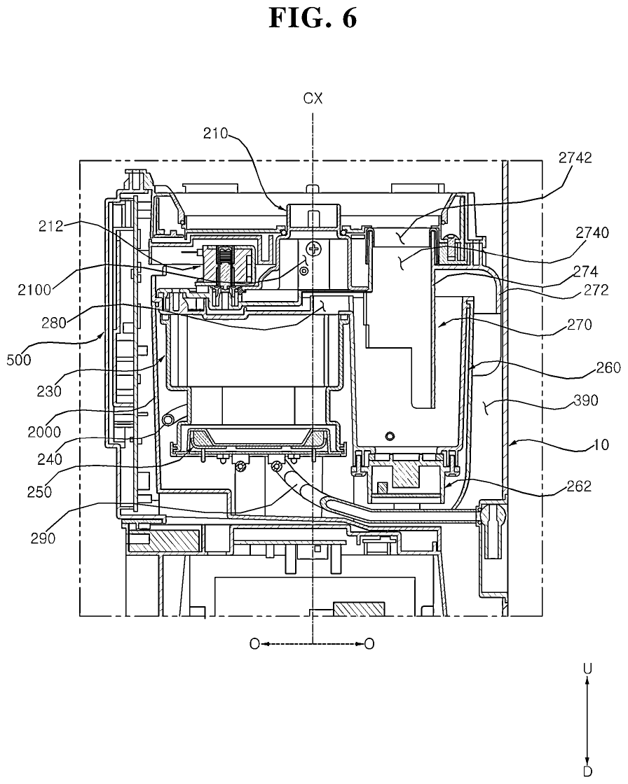

The humidifying device 200 may include a humidifying water tank 260. The water sterilized in the heating water tank 230 may move to the humidifying water tank 260 (Fs1). The humidifying water tank 260 may utilize water supplied from the heating water tank 230 to generate humidified air. In other examples, the humidifying device 200 may omit the heating water tank 230, and water may be directly supplied to the humidifying water tank 260 from the water rank 110. The humidifying water tank 260 may generate humidified air by using any one of an ultrasonic method, a heating method, an evaporation method, and a disk method. For example, the humidifying water tank 260 may generate humidified air by atomizing the supplied water by using an ultrasonic vibrator, such as vibration device 262 in FIG. 6. In other examples, the humidifying device 200 may combine the heating water tank 230 and the humidifying water tank 260 such that water is both sterilized and evaporated by a heater.

The blowing fan 350 may be disposed inside the case 10. The blowing fan 350 may be disposed in the lower portion of the humidifying device 200. The blowing fan 350 may form an air current that flows inside the case. The blowing fan 350 may form an airflow flowing from the suction hole 310 to the discharge hole 1600 (Fi). For example, the blowing fan 350 may form a rising airflow that flows from the suction hole 310 formed in the lower portion of the case 10 to the discharge hole 1600 formed in the upper surface of the case 10.

The case 10 may include a blowing flow path 390. The blowing flow path 390 may be formed inside the case 10. The blowing flow path 390 may be a flow path through which outward air blowing from the blowing fan 350 flows. The input air flowing in through the suction hole 310 may flow to the blowing fan 350 through the suction flow path 330 (Fi). The air passed through the blowing fan 350 may then flow into the blowing flow path 390 (Fi).

The case 10 may include a discharge flow path 1000. The discharge flow path 1000 may be formed inside the case 10. The air passed through the blowing flow path 390 may flow to the discharge flow path 1000 (Fd). The discharge flow path 1000 may be located above the blowing flow path 390. The discharge flow path 1000 may be located in the downstream side of the blowing flow path 390.

The discharge flow path 1000 may include a first discharge flow path 1000a and a second discharge flow path 1000b. The discharge hole 1600 may include a first discharge hole 1600a corresponding to the first discharge flow path 1000a, and a second discharge hole 1600b corresponding to the second discharge flow path 1000b.

The second discharge flow path 1000b may be formed inside the case 10. The first discharge flow path 1000a may be formed radially inside the second discharge flow path 1000b. The second discharge flow path 1000b may be connected to the blowing flow path 390. The second discharge flow path 1000b may be located in the downstream side of the blowing flow path 390. Some of the air passed through the blowing flow path 390 may flow upwards through the second discharge flow path 1000b (Fd2). The air that passed through the second discharge flow path 1000b bypasses the humidifying device and may be supplied to the indoor space through the second discharge hole 1600b (Fd2). In certain implementations, the second discharge flow path 1000b and the second discharge hole 1600b may be omitted from humidifier 1.

Some of a remaining portion of the air that passed through the blowing flow path 390 may be guided to flow into the humidifying device 200 (Fs2). This remaining portion of the air passed through the blowing flow path 390 may flow into the humidifying water tank 260 (Fs2). This remaining portion of the air flowing into the humidifying water tank 260 may be humidified within the humidifying water tank 260 and be output to flow into the first discharge flow path 1000a (Fd1). The humidified air flowing through the first discharge flow path 1000a may be supplied to the indoor space through the first discharge hole 1600a (Fd1).

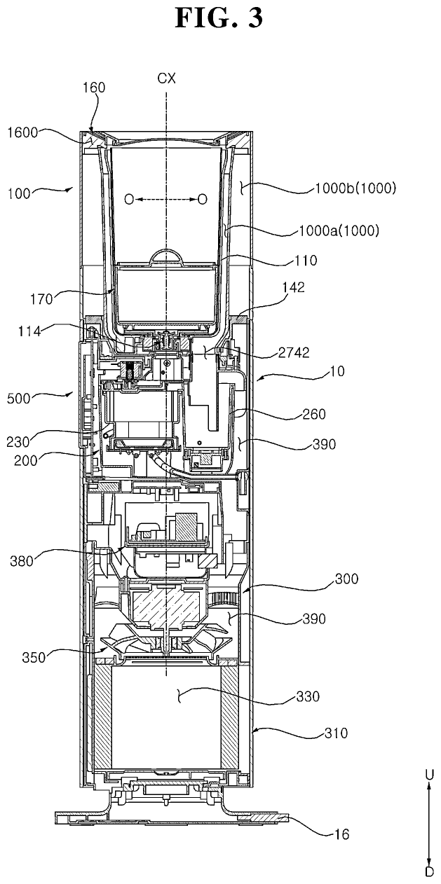

Referring to FIG. 3, the humidifier 1 in certain implementations may include a blower 300, a humidifying device 200, a flow path unit 100, a display 500, and an electrical equipment unit 380. The blower 300 may form an airflow. The blower 300 may be disposed inside the case 10. The blower 300 may form an airflow inside the case 10. The blower 300 may suction indoor air into the case 10 through the suction hole 310. The blower 300 may blow the suctioned air to the humidifying device 200 and/or the flow path unit 100. The blower 300 may form an airflow that pulls the humidity generated by the humidifying device 200. The blower 300 may provide power to discharge humidified air generated by the humidifying device 200 to the indoor space.

The humidifying device 200 may generate humidified air. The humidifying device 200 may be disposed inside the case 10. The humidifying device 200 may be disposed above the blower 300. The humidifying device 200 may discharge humidified air. At least a portion of the rising airflow formed from the blower 300 may be directed to the humidifying device 200 through the blowing flow path 390. The rising airflow may pull the humidity generated by the humidifying device 200 upward. The humidified air may be discharged through the discharge hole 1600 along with an upward airflow.

A flow path unit 100 may include a flow path through which air is discharged. The flow path unit 100 may include a discharge flow path 1000. The discharge flow path 1000 may include a first discharge flow path 1000a and a second discharge flow path 1000b. Humidified air generated by the humidifying device 200 may flow toward the first discharge hole 1600a through the first discharge flow path 1000a. The humidified air may be supplied to the indoor space through the first discharge hole 1600a. A portion of the air flowing in the blowing flow path 390 may bypass the humifying device 200 and flow to the second discharge hole 1600b through the second discharge flow path 1000b. The portion of non-humidified air may be supplied to the indoor space through the second discharge hole 1600b.

The display 500 may display information on the humidifier 1. The display 500 may include an output unit that displays information on the humidifier 1 to a user. Information on the humidifier 1 may include status information such as the level of water stored in the water tank 110, the amount of humidification discharged, the temperature and humidity of the indoor space, the quality of air in the indoor space, the concentration of fine dust in the indoor space, and the like. The display 500 may include an input unit, such as a touch sensor or one or more buttons through which a user's command may be input. A user may control the operation of the humidifier 1 through the display 500. For example, a user may control the humidification amount, air volume, operation time, turn on-off of lighting, the intensity of lighting, etc. through the display 500.

The electrical equipment unit 380 may transmit and receive electrical signals. The electrical equipment unit 380 may control the operation of the humidifier 1. The electrical equipment unit 380 may control the power supplied to the humidifier 1.

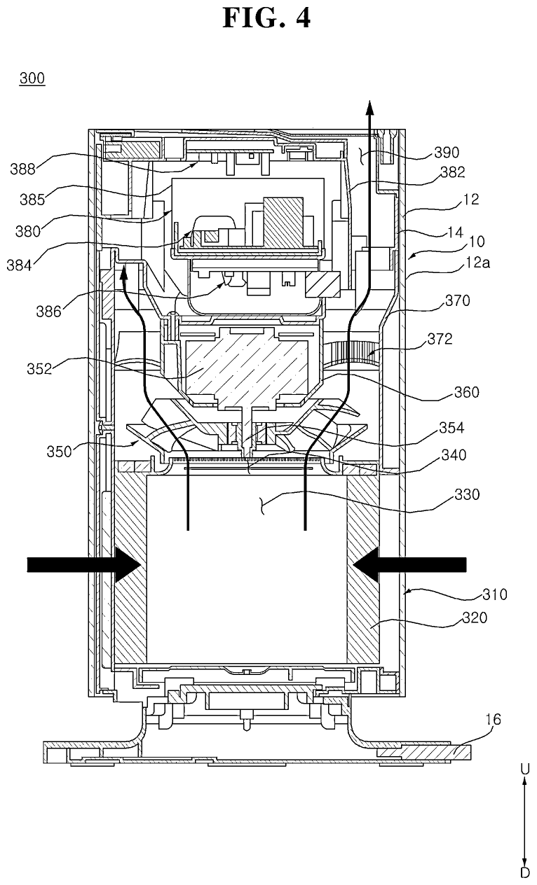

Referring to FIG. 4, the blower 300 in certain implementations of humidifier 1 may include a filter 320, a blowing fan (or impeller) 350, and a blower motor. The indoor air may be sucked into the blower 300 through the suction hole 310 formed in the case 10. The blower 300 may include a filter 320 that filters the sucked air. The filter 320 may be disposed inside the case 10. For example, the filter 320 may be disposed inside the cylindrical case 10, and may be formed in a cylindrical or other shape to correspond to an internal shape of the case 10 at suction hole 310. The air passed through the filter 320 may flow to the blowing fan 350 through the suction flow path 330. At least a portion of the suction flow path 330 may be formed inside the filter 320.

The blower 300 may include an orifice 340 located between the blowing fan 350 and the filter 320. The orifice 340 may be a hole through which the sucked air passes. The orifice 340 may be located between the suction flow path 330 and the blowing flow path 390. The orifice 340 may communicate with the suction flow path 330 and the blowing flow path 390. The orifice 340 may correspond to an inlet formed in the blowing fan 350. For example, the orifice 340 may correspond to the inlet formed in a shroud around the blowing fan 350. The sucked air may flow from the suction flow path 330 to the blowing fan 350 through the orifice 340, and may flow to the blowing flow path 390 by rotation of the blowing fan 350.

The blower 300 may include a blower motor 352 that rotates the blowing fan 350. The blower motor 352 may be connected to the blowing fan 350. For example, the shaft 354 of the blower motor 352 may be connected to the blowing fan 350. The blower motor 352 may be disposed above the blowing fan 350. The shaft 354 may extend downward from the blower motor 352, and may be connected to a hub of the blowing fan 350. As the blower motor 352 is driven, the blowing fan 350 may rotate to form an airflow.

The blower 300 may include a motor cover 360 in which the blower motor 352 may be disposed. The blower motor 352 may be accommodated in the motor cover 360. Inside the motor cover 360, the blower motor 352 may be disposed, and the blowing fan 350 may be disposed outside the motor cover 360. For example, the blowing fan 350 may be disposed below the motor cover 360. The shaft 354 of the blower motor 352 may penetrate the motor cover 360 and extend to the blowing fan 350.

The blower 300 may include a blower housing 370 that forms a blowing flow path 390. The blower housing 370 may be disposed inside the case 10. The blowing fan 350 and the blower motor 352 may be disposed inside the blower housing 370. The blowing flow path 390 may be formed between the motor cover 360 and the blower housing 370. The blower housing 370 may extend in the up-down direction.

The case 10 may include an inner case 14 and an outer case 12. The outer case 12 may form at least a portion of the outer shape of the case 10. The outer case 12 may include a plurality of louvers 12a. The plurality of louvers 12a may be disposed along the circumference of the outer case 12. The inner case 14 may be disposed inside the outer case 12. The inner case 14 may be disposed above the blower housing 370. For example, the inner case 14 and the blower housing 370 may be disposed inside the outer case 12, and the inner case 14 may be coupled to the upper side of the blower housing 370.

The blowing flow path 390 may be formed inside the case 10. The blowing flow path 390 may extend in the up-down direction inside the case 10. The blowing flow path 390 may have an annular cross-section shape or other shape. The blowing flow path 390 may be located in the downstream side of the blowing fan 350 to receive at least a portion of the blown air. The blowing fan 350 may be located between the suction flow path 330 and the blowing flow path 390. The motor cover 360 may be disposed inside the blower housing 370. The blowing flow path 390 may be formed between the motor cover 360 and the blower housing 370.

The electrical equipment unit 380 may be disposed above the blower motor 352. The electrical equipment unit 380 may be disposed inside the inner case 14. A blowing flow path 390 may be formed between the electrical equipment unit 380 and the inner case 14. Accordingly, at least a portion of the blown air from blowing fan 350 may be directed to the humidifying device 200 along the blowing flow path 390.

The blower 300 may include an air diffuser 372 disposed in the blowing flow path 390. The air diffuser 372 may control the directionality of the airflow flowing in the blowing flow path 390. For example, the air diffuser 372 may extend along blowing flow path 390 to straighten the airflow flowing through the blowing flow path 390. The air diffuser 372 may be disposed in the outside of the motor cover 360. The air diffuser 372 may be disposed inside the blower housing 370. For example, the air diffuser 372 may include a plurality of air diffusers 372 disposed between the motor cover 360 and the blower housing 370, and the plurality of air diffusers 372 may be spaced apart from each other in the circumferential direction of the cross section of the blowing flow path 390. A portion of the blowing flow path 390 may be formed between the plurality of air diffusers 372.

Referring to FIG. 4, the blower 300 in certain implementations of humidifier 1 may include an electrical equipment unit 380. The electrical equipment unit 380 may include a controller (or control unit) 388 that controls the operation of components of the humidifier 1. The controller 388 may control operation of the blower 300, the humidifying device 200, display 500, a lights with case 10, etc. For example, the controller 388 may be a microcontroller (MCU) or a printed circuit board (PCB).

The electrical equipment unit 380 may include a power supply device (or power supply) 384 that receives external power and supplies electrical energy to components of the humidifier 1. For example, the power supply device 384 may supply electrical energy to the humidifying device 200, the blower 300, the display 500, or other components of the humidifier 1. The power supply device 384 may include a rectifier, such as to convert input AC power into DC power supplied to the components of the humidifier 1.

The electrical equipment unit may include a phase control device (or phase controller) 386. The phase control device 386 may convert the voltage and current input to the humidifying device 200. For example, the phase control device 386 may convert the power input to the heater 250 of the water tank 230.

The electrical equipment unit 380 may include a communication device that transmits and receives data. The communication device may include a wireless communication device. The communication device may use wireless communication technologies such as Wi-Fi®, Bluetooth®, and cellular. The communication device may transmit and receive data to other devices.

The electrical equipment unit 380 may include or may be coupled to a sensor that detects information on the humidifier or the indoor space. For example, the sensor may include at least one of a temperature sensor that detects the temperature of the indoor space and a humidity sensor that detects the humidity of the indoor space.

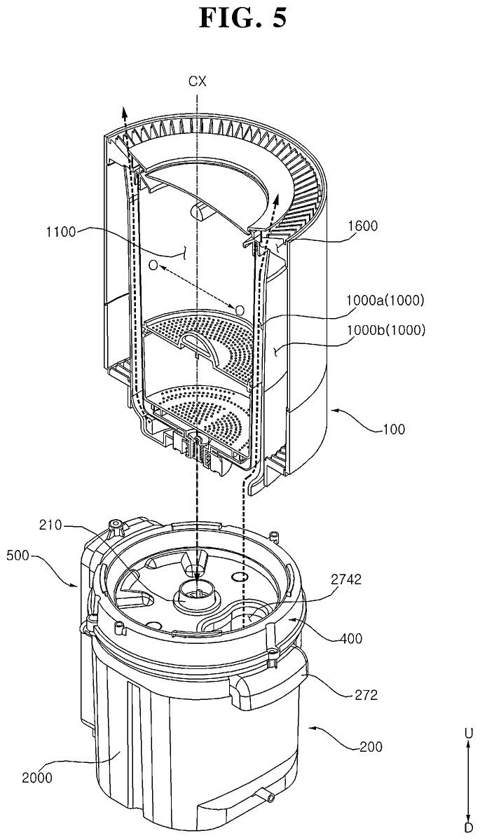

Referring to FIG. 5, humidified air discharged from the humidifying device 200 may be discharged through the flow path unit 100 in certain implementations of humidifier 1. The humidifying device 200 may include a main housing 2000, a supply pipe 210, and a humid air outlet 2742, and the main housing 2000 may form the outer shape of the humidifying device 200.

Water stored in a water storage space 1100 may flow into the humidifying device 200 through the supply pipe 210. The humidifying device 200 may generate humidified air by using water supplied through the supply pipe 210. The supply pipe 210 may be extend upwards from or may be disposed above the humidifying device 200. The supply pipe 210 may extend upward. For example, water stored in the water storage space 1100 located above the humidifying device 200 may flow into the humidifying device 200 through the supply pipe 210 located above the humidifying device 200.

Humidified air generated in the humidifying device 200 may be discharged through the humid air outlet 2742. The humid air outlet 2742 may be formed above the humidifying device 200. The humid air outlet 2742 may be an opening provide in the upper surface of the humidifying device 200.

The middle tray 400 may be disposed above the humidifying device 200. The middle tray 400 may be coupled to the upper surface of the humidifying device 200. The middle tray 400 may be disposed between the humidifying device 200 and the flow path unit 100. The middle tray 400 may capture and direct water spilled from water tank 110, such as to direct the spilled water toward the humid air outlet 2742 to flow into the humidifying device 200.

The display 500 may be disposed in one side of the humidifying device 200. The display 500 may be coupled to one side of a main housing 2000. The display 500 may be coupled to one side of the middle tray 400. For example, the middle tray 400 may be disposed above the humidifying device 200, and the display 500 may be disposed in the side surface of the humidifying device 200.

Continuing with FIG. 5, the flow path unit 100 may include a water storage space 1100, a discharge flow path 1000, and a discharge hole 1600. The water storage space 1100 may be formed inside the flow path unit 100. The water stored in the water storage space 1100 may be supplied to the humidifying device 200. For example, the water stored in the water storage space 1100 may flow into the humidifying device 200 through the supply pipe 210 located below the water storage space 1100.

The discharge flow path 1000 may be located inside a side of the flow path unit 100. The discharge flow path 1000 may be located outside the water storage space 1100 in a radial direction. The discharge flow path 1000 may be located between the peripheral wall of the flow path unit 100 and the water storage space 1100. The discharge flow path 1000 may include a first discharge flow path 1000a located in the outside of the water storage space 1100, and a second discharge flow path 1000b located in the outside of the first discharge flow path 1000a. The first discharge flow path 1000a may be located between the water storage space 1100 and the second discharge flow path 1000b. The second discharge flow path 1000b may be located between the first discharge flow path 1000a and the peripheral wall of the flow path unit 100.

Humidified air discharged from the humidifying device 200 may flow through the discharge flow path 1000. For example, the humidified air discharged from the humid air outlet 2742 may flow through the first discharge flow path 1000a. Humidified air flowing through the first discharge flow path 1000a may be supplied to the indoor space through the discharge hole 1600. The first discharge flow path 1000a and the second discharge flow path 1000b are joined at the discharge hole 1600. The first discharge flow path 1000a may be connected to the humid air outlet 2742. The second discharge flow path 1000b may be connected to the blowing flow path 390 to receive and guide non-humidified air flowing within the case 10.

Referring to FIG. 6, the humidifying device 200 included in certain implementations of humidifier 1 may include a main housing 2000, a supply pipe 210, a first valve 212, a heating water tank 230, a first connection pipe 240, a drain pipe 290, a humidifying water tank 260, and a compartment cover 270. The main housing 2000 may be disposed inside the case 10. The main housing 2000 may accommodate at least one of a heating water tank 230 and a humidifying water tank 260, which will be described later. The upper side of the main housing 2000 may be opened, such as to be coupled to middle tray 400.

The supply pipe 210 may be a pipe through which water is supplied to the humidifying device 200. The supply pipe 210 may be connected to the humidifying device 200. The water stored in the water tank 110 may be supplied to the humidifying device through the supply pipe 210. 200. For example, water stored in the water tank 110 may be moved to the heating water tank 230 through the supply pipe 210. A supply chamber 2100 may be formed inside the supply pipe 210. The water flowing into the supply pipe 210 may pass through the supply chamber 2100 and then flow into the heating water tank. The water flowing into the supply pipe 210 may be temporarily stored in the supply chamber 2100.

The first valve 212 may control the flow of water supplied to the humidifying device 200 through the supply pipe 210. For example, when the first valve 212 is opened, the water stored in the supply chamber 2100 may be moved to the heating water tank 230. Conversely, when the first valve 212 is closed, the supplied water may be temporarily stored in the supply chamber 2100. The first valve 212 may be opened and closed according to an electrical signal of the electrical equipment unit 380. The first valve 212 may be supplied with power from the electrical equipment unit 380. For example, the first valve 212 may be a solenoid or other valve that is selectively opened or closed based on a signal received from electrical equipment unit 380. The first valve 212 may be disposed above the heating water tank 230. The first valve 212 may be disposed in the supply pipe 210. For example, the first valve 212 may be disposed between the heating water tank 230 and the supply pipe 210. The first valve 212 may be spaced upward from the heating water tank 230. For example, the first valve 212 may be spaced upward from the upper surface of the heating water tank 230.

The heating water tank 230 may be disposed inside the main housing 2000. The heating water tank 230 may heat water flowing in through the supply pipe 210. The heating water tank 230 may heat water to sterilize and/or evaporate the water. The water heated in the heating water tank 230 may flow to the humidifying water tank 260.

The first connection pipe 240 may be a pipe through which water stored in the heating water tank 230 flows to the humidifying water tank 260. The height of the first connection pipe 240 may decrease as it progresses downstream. The first connection pipe 240 may be inclined downward toward the downstream side. The first connection pipe 240 may have high thermal conductivity. The temperature of water heated in the heating water tank 230 may decrease while flowing through the first connection pipe 240.

The drain pipe 290 may be connected to the heating water tank 230. The drain pipe 290 may discharge residual water stored in the heating water tank 230. The remaining water may be discharged to the outside of the case 10 through the drain pipe 290. The drain pipe 290 may be connected to the lower portion of the heating tank 230. For example, the drain pipe 290 may be connected to the bottom surface of the heating tank 230.

The humidifying water tank 260 may generate humidified air by using supplied water. Humidified air may refer to air containing mist and/or water vapor. The humidifying water tank 260 may generate humidified air by using, for example, one or more of an ultrasonic method, a heating method, an evaporation method, and a disk method. For example, the humidifying water tank 260 may generate humidified air by atomizing supplied water by using an ultrasonic vibrator. The humidifying water tank may be equipped with a vibration device 262.

The vibration device 262 may be disposed in the bottom surface of the humidifying water tank 260. The vibration device 262 may split the supplied water into fine particles by using ultrasonic vibration. The vibration device 262 may atomize supplied water electrically. For example, the vibration device 262 may include a piezoelectric element that vibrates based on electrical power received from the electrical equipment unit 380 to atomize water within humidifying water tank 260.

The compartment cover 270 may be disposed above the main housing 2000. The compartment cover 270 may cover the upper side of the humidifying water tank 260. The compartment cover 270 may partition a flow path flowing into the humidifying water tank 260 and a flow path flowing out from the humidifying water tank 260. For example, the compartment cover 270 may include an air supply pipe 210 which may be a flow path through which a portion of the rising airflow flowing through the blowing flow path 390 flows into the humidifying water tank 260, and a discharge pipe 274 through which the portion of the rising airflow flowing into the humidifying water tank 260 and the mist stagnant in the humidifying water tank 260 are discharged together as humidified. The air supply pipe 210 may connect the blowing flow path 390 and the humidifying water tank 260. The rising airflow that flows into the humidifying water tank 260 through the blowing flow path 390 may mix with and pull out the mist generated in the humidifying water tank 260. Through this mixing, the mist generated in the humidifying water tank 260 may be discharged toward discharge port 1600. The discharge pipe 274 may extend in an up-down direction. The discharge pipe 274 may form a discharge flow path 2740. The humid air outlet 2742 may be formed at one end of the discharge pipe 274. A lower portion of the discharge pipe 274 may be inserted into the humidifying water tank 260.

The humidifying device 200 may include a communication flow path 280 that connects the heating water tank 230 and the humidifying water tank 260. The communication flow path 280 may connect the upper portion of the heating water tank 230 and the upper portion of the humidifying water tank 260. In the heating water tank 230, water vapor may be generated in the process of heating and sterilizing the supplied water. The generated water vapor may flow into the humidifying water tank 260 through the communication flow path 280. The discharge pipe 274 may be open toward the communication flow path 280. The communication flow path 280 may be connected to the discharge flow path 2740. Water vapor that moves from the heating water tank 230 to the humidifying water tank 260 through the communication flow path 280 may be discharged through the discharge pipe 274. Through this movement of the water vapor into the humidifying water tank 260, the humidified air discharged from the humidifying water tank 260 may include water vapor generated in the heating water tank 230, mist generated in the humidifying water tank 260, and a rising airflow formed by the blowing fan 350.

Referring to FIG. 6, the humidifier 1 in certain implementations may include a display 500. The display 500 may be disposed in one side of the humidifying device 200. The display 500 may be coupled to one side of the main housing 2000. For example, the display 500 may be coupled to the side surface of the humidifying device 200. The display 500 may be spaced apart from the humidifying water tank 260 in the horizontal direction. The display 500 may be spaced apart in the horizontal direction from the discharge pipe 274 through which humidified air generated in the humidifying water tank 260 is discharged. The supply pipe 210 may be disposed between the display 500 and the discharge pipe 274. For example, the display 500 and the discharge pipe 274 may be disposed in opposite sides in the horizontal direction based on the central axis of the case 10. For example, based on the central axis of the case 10, the display 500 may be disposed in the front surface of the case 10, and the humid air outlet 2742 may be disposed in the rear of the case 10.

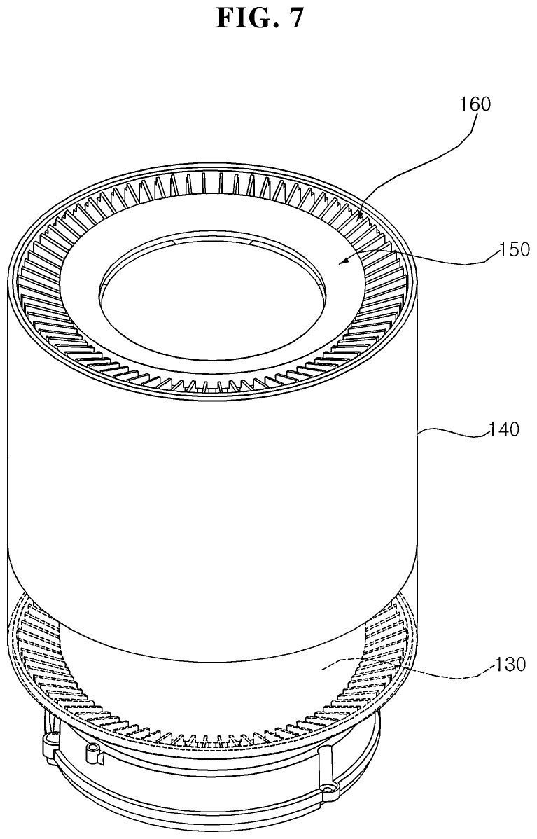

Referring to FIG. 7, the flow path unit 100 in certain implementations of humidifier 1 may include a shell 130, 140, a discharge grill 160, and a water tank cover 150. The flow path unit 100 may include the shell 130, 140. The case 10 may include the shell 130, 140. The shell 130, 140 may form the outer shape of the flow path unit 100. The shell 130, 140 may have an accommodating space formed therein. The water tank 110 may be accommodated in the shell 130, 140. A discharge flow path 1000 may be formed inside the shell 130, 140. The upper side of the shell 130, 140 may be open. A discharge hole 1600 may be formed above the shell 130, 140.

The discharge grill 160 may be disposed above the shell 130, 140. As previously described, the discharge grill 160 may be disposed in the discharge hole 1600. The discharge grill 160 may be disposed in the upper end of the shell 130, 140. For example, the discharge grille 160 may extend along the inner circumference of the upper end of the shell 130, 140. The discharge grille 160 may include a plurality of vanes to guide air flow from the discharge hole 1600.

The water tank cover 150 may be disposed above the shell 130, 140. As previously described, the water tank cover 150 may cover the open upper side of the water tank 110. The water tank cover 150 may open or close the water tank 110. The water tank cover 150 may be disposed radially inside the discharge grill 160. For example, the water tank cover 150 may be disposed at the center of the annular discharge grill 160. For example, the water tank 110 may be disposed at the center of the shell 130, 140, and the water tank cover 150 may cover the open upper side of the water tank 110.

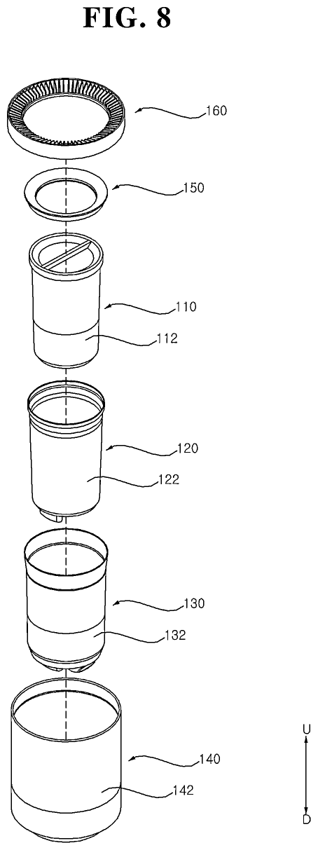

Referring to FIG. 8, the flow path unit 100 in certain implementations of humidifier 1 may include a water tank 110, a water tank cover 150, a water tank housing 120, an inner shell 130, an outer shell 140, and a discharge grill 160. The water tank 110 may be formed in a substantially cylindrical shape. The water tank 110 may extend in the up-down direction. A water storage space 1100 may be formed inside the water tank 110. The discharge grill 160 may extend along the circumference of the upper end of the water tank 110. The discharge grill 160 may be disposed in the outside of the upper end of the water tank 110. The water tank 110 may include a water tank peripheral wall 112 that forms the outer shape. The water tank peripheral wall 112 may partition the water storage space 1100 of the water tank 110.

The water tank housing 120 may accommodate the water tank 110. The water tank housing 120 may form an internal space in which the water tank 110 is disposed. The water tank housing 120 may surround the water tank 110. The water tank housing 120 may be a holder of the water tank 110. The water tank housing 120 may cover the water tank peripheral wall 112 of the water tank 110. The water tank 110 may be fitted to the water tank housing 120. The water tank peripheral wall 112 may be in close contact with the inner peripheral wall of the water tank housing 120. The water tank housing 120 may be fixed to prevent the inserted water tank 110 from moving in the horizontal direction. The water tank housing 120 may be maintained horizontally so that the water tank 110 does not fall inside the case 10. The water tank housing 120 and the water tank 110 may be separated from the case 10 respectively. The water tank housing 120 may include a housing peripheral wall 122 that partitions the internal space.

The shell 130, 140 may include the inner shell 130. The case 10 may include the inner shell 130. The inner shell 130 may accommodate the water tank 110 and/or the water tank housing 120. The inner shell 130 may be spaced outwardly from the water tank 110 and/or the water tank housing 120. The first discharge flow path 1000a may be formed in a gap between the inner shell 130 and the water tank housing 120. Thus, the first discharge flow path 1000a may be formed between the water tank 110 and the inner shell 130. The second discharge flow path 1000b may be formed in a second gap between the inner shell 130 and the case 10. As previously described, humidified air generated in the humidifying device 200 may flow through the first discharge flow path 1000a. In this example, the inner shell 130 may partition the first discharge flow path 1000a and the second discharge flow path 1000b. The inner shell 130 may include an inner peripheral wall 132 that partitions the internal space between case 10 and water thank 110 into the first discharge flow path 1000a and the second discharge flow path 1000b.

The shell 130, 140 may include an outer shell 140. The case 10 may include an outer shell 140. The outer shell 140 may form the outer shape of the flow path unit 100. The outer shell 140 may have an internal space. The outer shell 140 may have an open upper side. The outer shell 140 may accommodate the water tank 110, the water tank housing 120, and/or the inner shell 130. The outer shell 140 may be spaced outwardly from the water tank 110, the water tank housing 120, and/or the inner shell 130. The discharge flow path 1000 may be formed inside the shell 140. The discharge flow path 1000 may be formed between the outer shell 140 and the water tank 110. For example, the first discharge flow path 1000a may be formed between the water tank housing 120 and the inner shell 130, and the second discharge flow path 1000b may be formed between the inner shell 130 and the outer shell 140. The outer shell 140 may include an outer peripheral wall 142 that divides the internal space between inner shell 130 and case 10, such as to define the second discharge flow path 1000b.

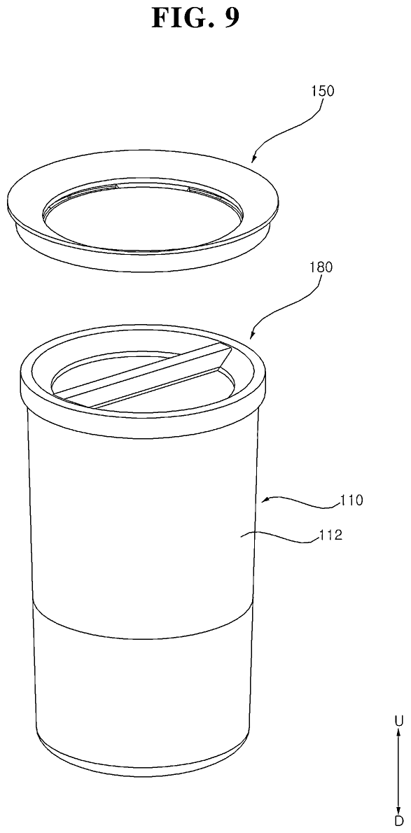

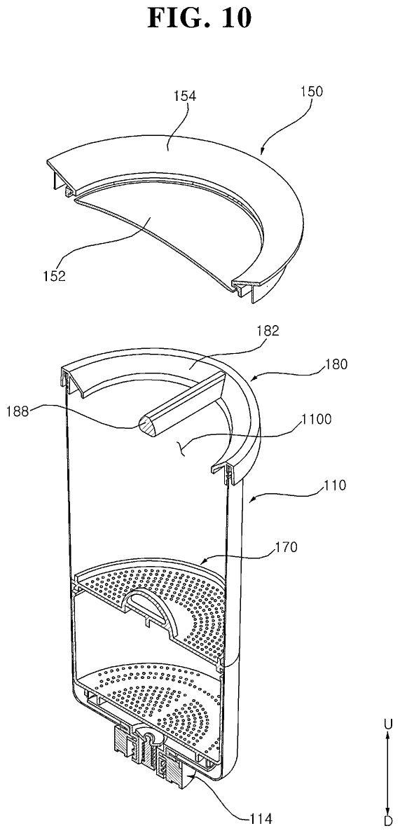

Referring to FIGS. 9 and 10, the humidifier 1 in certain implementations may include a water tank handle 180, an ion exchange resin 170, and an injection device 114. The water tank handle 180 may be fixed to the water tank 110. The water tank handle 180 may be rotated and fastened to the water tank 110. The water tank handle 180 may be coupled to the upper end of the water tank 110. The water tank cover 150 may be disposed above the water tank handle 180. The water tank cover 150 may cover at least a portion of the water tank handle 180. The water tank handle 180 may be disposed between the water tank cover 150 and the water tank 110.

The water tank handle 180 may include a handle rim 182 coupled to the upper end of the water tank 110. The handle rim 182 may be fixed to the upper end of the water tank 110. The handle rim 182 may extend along the circumference of the upper end of the water tank 110. The handle rim 182 may be formed in an annular shape. The handle rim 182 may guide water into the water tank 110.

The water tank handle 180 may include a handle bar 188. The handle bar 188 may be fixed to the handle rim 182. A user may move the water tank 110 by holding and manipulating the handle bar 188. For example, a user may hold the handle bar 188 and pull it upward to separate the water tank 110 from the case 10. In addition, a user may push the handle bar 188 downwards when inserting the water tank 110 into the case 10. The handle bar 188 may be formed in a straight line to form a bar or other shape. The handle bar 188 may be coupled to the handle rim 182. The handle bar 188 may extend through a center space of the handle rim and may extend to the handle rim 182 in the diametric direction.

The ion exchange resin 170 may be disposed inside the water tank 110. The ion exchange resin 170 may be disposed in the water storage space 1100. The ion exchange resin 170 may be in relatively close contact with the inner side surface of the water tank 110. The ion exchange resin 170 may change the composition of the water stored in the water storage space 1100. The ion exchange resin 170 may exchange ion with the water stored in the water storage space 1100. The ion exchange resin 170 may selectively remove or replenish some ions contained in the water stored in the water storage space 1100. The ion exchange resin 170 may include a cation exchange resin and an anion exchange resin. The cation exchange resin may absorb cations contained in the water stored in the water storage space 1100. The cation exchange resin may emit cations to the water stored in the water storage space 1100. The anion exchange resin may absorb anions contained in the water stored in the water storage space 1100. The anion exchange resin may emit anions from the water stored in the water storage space 1100.

The injection device 114 may be disposed in one side of the water tank 110. The injection device 114 may be detachably coupled to the water tank 110. For example, the injection device 114 may be detachably coupled to the lower surface of the water tank 110. The injection device 114 may discharge the water stored in the water storage space 1100 out of the water tank 110. The injection device 114 may be mounted in or otherwise coupled to the supply pipe 210 of the humidifying device 200. The injection device 114 may inject water stored in the water storage space 1100 into the supply pipe 210.

Referring to FIG. 10, the water tank cover 150 in certain implementations of humidifier 1 may include a guide rim 154 and a guide cover 152. The guide rim 154 may form the circumference of the water tank cover 150. That is, the guide rim 154 may form the rim of the water tank cover 150. The guide rim 154 may be formed in an annular shape having an open center.

The guide cover 152 may be disposed inside the guide rim 154. The guide cover 152 may be disposed at the center of the guide rim 154. For example, the guide cover 152 may be disposed in the open center of the guide rim 154. The guide cover 152 may be formed in a substantially circular shape or other shape to be coupled to guide rim 154 and to be provided over an open end of the water tank 110. For example, the guide cover 152 may have a circular plate shape disposed in the circular center opening of the guide rim 154.

A water supply hole or path may be formed between the guide rim 154 and the guide cover 152. For example, a water supply hole may be formed between the inner circumference of the guide rim 154 and the outer circumference of the guide cover 152, and water may flow between the guide rim 154 and the guide cover 152 via the water supply hole.

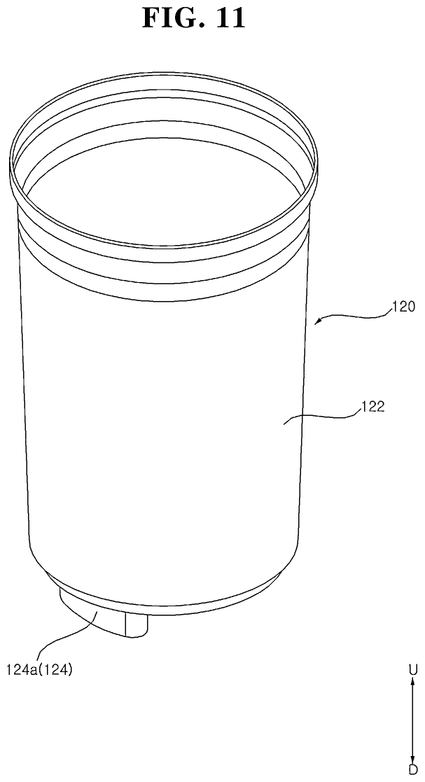

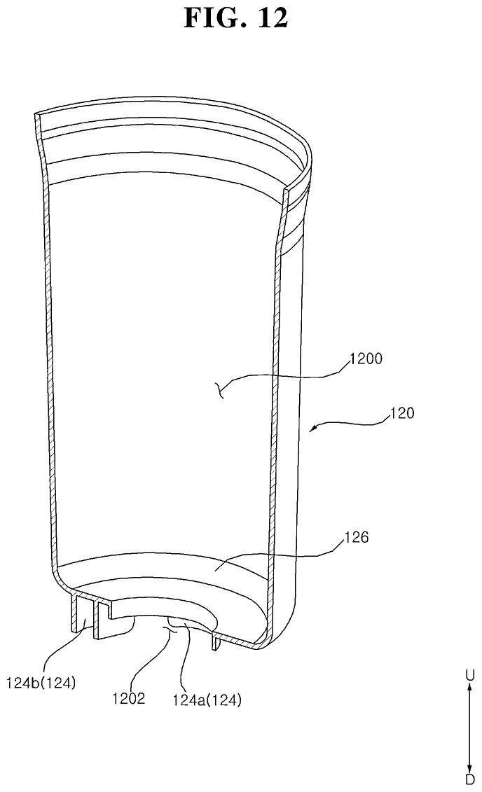

Referring to FIGS. 11 and 12, the water tank housing 120 in certain implementations of humidifier 1 may include a housing support (or housing legs) 124 and a housing injection hole 1202. The housing support 124 may extend downward from the water tank housing 120. The housing support 124 may be formed in the lower surface of the water tank housing 120. The housing support 124 may include a first housing support 124a and a second housing support 124b. The housing support 124 may extend downward from the lower surface of the water tank housing 120. The housing support 124 may support a load the water tank housing 120. The housing support 124 may transmit the load of the water tank housing 120 downward.

The housing support 124 may include a first housing support 124a and a second housing support 124b. The first housing support 124a may protrude from the water tank housing 120. The first housing support 124a may extend from the lower surface of the water tank housing 120. For example, the first housing support 124a may extend in a downward direction from the lower surface of the water tank housing 120. The first housing support 124a may support the water tank housing 120. The first housing support 124a may transmit the load of the water tank housing 120 and/or the water tank 110 downward. The first housing support 124a may extend in the circumferential direction of the water tank housing 120. There may be a plurality of first housing supports 124a. The plurality of first housing supports 124a may be disposed in the lower surface of the water tank housing 120 to be spaced apart from each other. The plurality of first housing supports 124a may be disposed in the circumferential direction in the lower surface of the water tank housing 120. The plurality of first housing supports 124a may be radially disposed in the lower surface of the water tank housing 120. For example, a pair of first housing supports 124a may extend downward from the lower surface of the water tank housing 120, and the pair of first housing supports 124a may be spaced apart in opposite radial directions based on the center of the lower surface of the water tank housing 120.

The second housing support 124b may protrude from the water tank housing 120. The second housing support 124b may extend from the lower surface of the water tank housing 120. For example, the second housing support 124b may extend in a downward direction from the lower surface of the water tank housing 120. The second housing support 124b may support the water tank housing 120. The second housing support 124b may transmit the load of the water tank housing 120 and/or the water tank 110 downward. The second housing support 124b may extend in the circumferential direction of the water tank housing 120. The second housing support 124b may prevent the water tank housing 120 from falling. The second housing support 124b may be located between the plurality of first housing supports 124a. For example, the pair of first housing supports 124a may be located spaced apart in a first radial direction and in a direction opposite to the first radial direction based on the center of the lower surface of the water tank housing 120, and the second housing support 124b may be located in a second radial direction perpendicular to the first radial direction. For example, one of the second housing supports 124b may be located between a pair of first housing supports 124a.

The water tank housing 120 may include an insertion space 1200 in which the water tank 110 may be accommodated. The insertion space 1200 may be formed inside the water tank housing 120. The insertion space 1200 may be defined by the housing peripheral wall 122 of the water tank housing 120.

The injection device 114 may extend from and penetrate the lower surface of the water tank housing 120. The injection device 114 may protrude at the lower surface of the water tank housing 120. The injection device 114 may be mounted in or otherwise coupled to the supply pipe 210 of the humidifying device 200.

The housing injection hole 1202 may be a through hole formed in the water tank housing 120. The injection device 114 may be disposed in the housing injection hole 1202. The injection device 114 may penetrate the housing injection hole 1202 and protrude to the lower side of the water tank housing 120. The injection device 114 protruding downward may be mounted in the supply pipe 210 of the humidifying device 200.

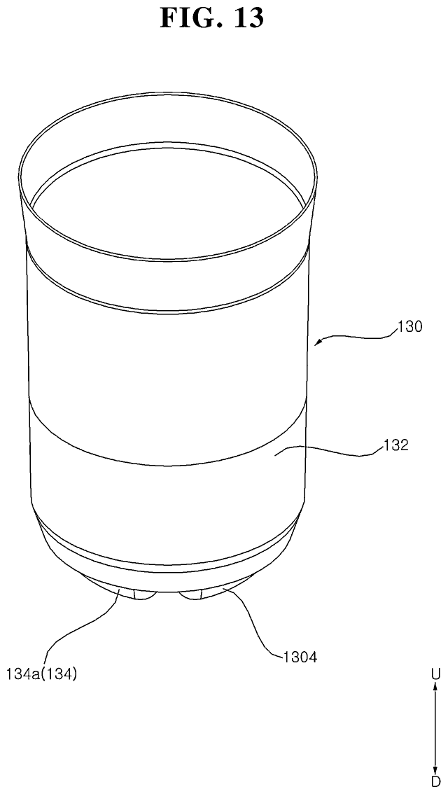

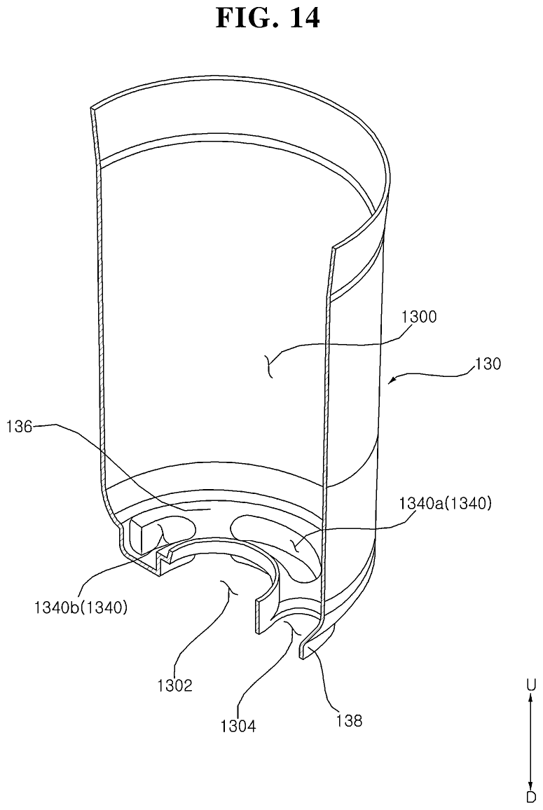

Referring to FIGS. 13 and 14, the inner shell 130 in certain implementations of humidifier 1 may include an insertion space, a shell support 134, a shell inlet 1304, and a shell injection hole 1302. The inner shell 130 may include an insertion space 1300 in which the water tank 110 and/or the water tank housing 120 may be accommodated. The water tank 110 and/or the water tank housing 120 may be inserted into the insertion space 1300 through the open upper side of the inner shell 130. The volume of the insertion space 1300 may be larger than the volume of the water tank 110 and/or the water tank housing 120. The insertion space 1300 may be partitioned and defined by the inner peripheral wall 132.

The shell support 134 may extend downward from the inner shell 130. The shell support may be formed on the lower surface of the inner shell 130. The shell support 134 may extend from the lower surface of the inner shell 130. The shell support may support the inner shell 130. The shell support 134 may transmit the load of the inner shell 130 downward.

The shell support 134 may include a first shell support 134a and a second shell support 134b. The first shell support 134a may protrude from the inner shell 130. The first shell support 134a may extend from the lower surface of the inner shell 130. For example, the first shell support 134a may extend downward from the lower surface of the inner shell 130. The first shell support 134a may support the inner shell 130. The first shell support 134a may transmit the load of the inner shell 130, the water tank housing 120, and/or the water tank 110 downward. There may be a plurality of first shell supports 134a. The plurality of first shell supports 134a may be disposed in the lower surface of the inner shell 130 to be spaced apart from each other. The plurality of first shell supports 134a may be disposed around the lower surface of the inner shell 130. A plurality of first shell supports 134a may be radially disposed in the lower surface of the inner shell 130. For example, a pair of first shell supports 134a extend downward from the lower surface of the inner shell 130, and the pair of first shell supports 134a may be spaced apart in opposite radial directions based on the center of the lower surface of the inner shell 130.

A first support insertion portion 1340a may be formed inside the first shell support 134a. That is, the first support insertion portion 1340a may correspond to the inner space of the first shell support 134a. The first housing support 124a may be disposed inside the first shell support 134a. The first housing support 124a may transmit a load of water tank housing 120 to the first shell support 134a. The location of the first shell support 134a may correspond to the location of the first housing support 124a. The number of first shell supports 134a may correspond to the number of first housing supports 124a.

The inner shell 130 may include a second shell support 134b. The second shell support 134b may protrude from the inner shell 130. The second shell support 134b may extend from the lower surface of the inner shell 130. For example, the second shell support 134b may extend downward from the lower surface of the inner shell 130. The second shell support 134b may support the inner shell 130. The second shell support 134b may transmit the load of the inner shell 130. The second shell support 134b may prevent the inner shell 130 from falling. The second shell support 134b may be located between the plurality of first shell supports 134a. For example, a pair of first shell supports 134a may be located spaced apart in a first radial direction and in a direction opposite to the first radial direction based on the center of the lower surface of the inner shell 130, and the second shell support 134b may be located in a second radial direction perpendicular to the first radial direction.

A second support insertion portion 1340b may be formed inside the second shell support 134b. For example, the second support insertion portion 1340b may correspond to an internal space of the second shell support 134b. The second housing support 124b may be received and disposed inside the second shell support 134b. The second housing support 124b may transmit a load of the water tank housing 120 to the second shell support 134b. The location of the second shell support 134b may correspond to the location of the second housing support 124b. The number of second shell supports 134b may correspond to the number of second housing supports 124b.

The inner shell 130 may include a support insertion portion (or support insertion region) 1340 where the housing support 124 may be disposed. The support insertion portion 1340 may include a first support insertion portion 1340a. The first housing support 124a may be disposed in the first support insertion portion 1340a. The first support insertion portion 1340a may be recessed from a bottom surface 136 of the inner shell 130.

The support insertion part 1340 may include a second support insertion part (or second support insertion region) 1340b. The second housing support 124b may be disposed in the second support insertion portion 1340b. The second support insertion portion 1340b may be recessed from the bottom surface 136 of the inner shell 130.

The inner shell 130 may include a shell inlet 1304 through which humidified air flows into an interior of the inner shell 130 from the humidifying device 200. The shell inlet 1304 may be formed in the lower surface of the inner shell 130. The shell inlet 1304 may correspond to the humid air outlet 2742 of the humidifying device 200. For example, the humidified air generated in the humidifying device 200 may be discharged through the humid air outlet 2742, and the discharged humidified air may flow into the inner shell 130 through the shell inlet 1304. The inflow humidified air may flow through the first discharge flow path 1000a formed inside the inner shell 130.

The inner shell 130 may include a protruding rim 138 corresponding to the humid air outlet 2742. The protruding rim 138 may be provided at a circumference of the shell inlet 1304. The protruding rim 138 may extend to one side (e.g., downwards) from the circumference forming the shell inlet 1304. The protruding rim 138 may be in close contact with the discharge pipe 274 of the humidifying device 200. The cross-sectional shape of the protruding rim 138 may correspond to the cross-sectional shape of the discharge pipe 274 of the humidifying device 200. The lower end of the protruding rim 138 may be located on substantially the same plane as the lower end of the shell support 134. For example, the lower end of the protruding rim 138 may be located on the same horizontal plane as the lower end of the first shell support 134a and the lower end of the second shell support 134b. The protruding rim 138 may support the inner shell 130. The protruding rim 138 may help to prevent the inner shell 130 from tipping over.

The inner shell 130 may include a shell injection hole 1302 into which the injection device 114 may be inserted. The shell injection hole 1302 may be formed on the inner bottom surface 136 of the inner shell 130. The shell injection hole 1302 may be a through hole formed substantially in the center of the bottom surface of the inner shell 130. The circumference forming the shell injection hole 1302 may extend upward. For example, a peripheral wall extending upward from the circumference of the shell injection hole 1302 may surround the injection device 114.

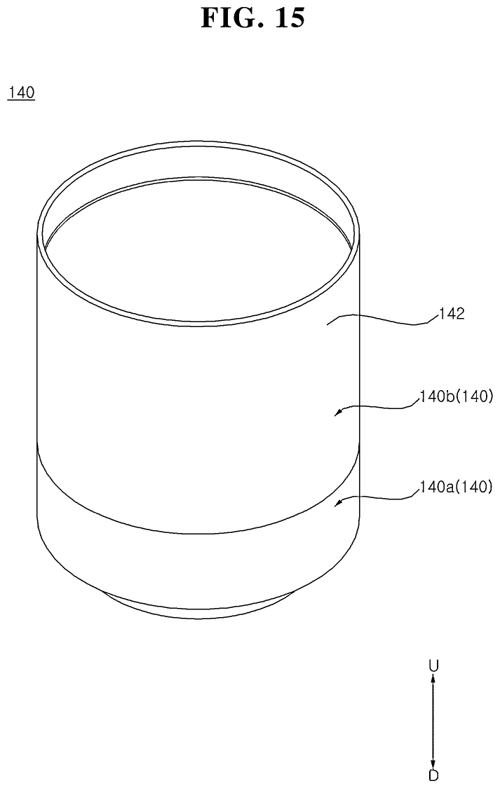

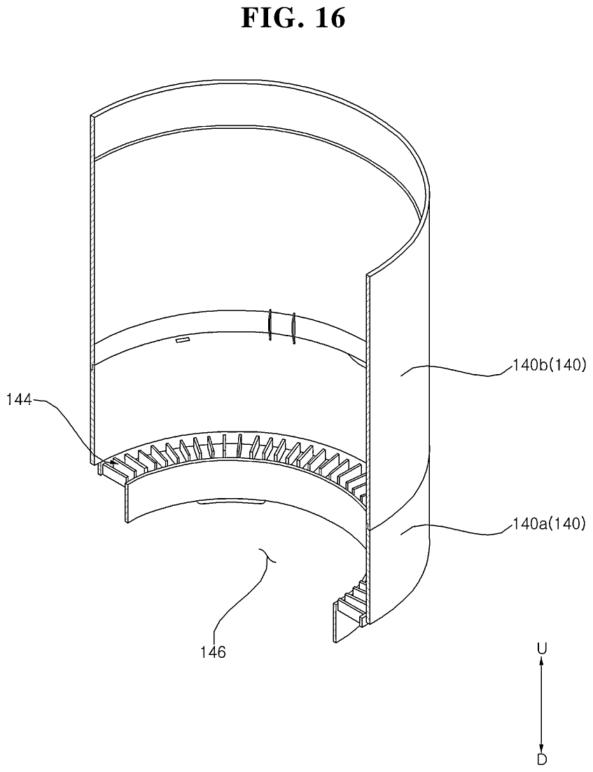

Referring to FIGS. 15 and 16, the outer shell 140 in certain implementations of humidifier 1 may include a first outer shell 140a, a second outer shell 140b, a shell opening 146, and a blowing grill 144. The outer shell 140 may include the first outer shell 140a and the second outer shell 140b coupled to the upper side of the first outer shell 140a. The first outer shell 140a may be formed so that the inside of outer shell 140 may be visible. The first outer shell 140a may be formed of a light-transmissive material, such as glass or acrylic. For example, the first outer shell 140a may be formed transparent. The second outer shell 140b may be formed so that the inside is invisible. For example, the second outer shell 140b may be formed with a non-light transmissive material to be opaque. The second outer shell 140b may extend from the upper end of the first outer shell 140a. For example, the first outer shell 140a may form the lower portion of the outer shell 140, and the second outer shell 140b may form at least a part of the remaining, upper portion of the outer peripheral wall 142 of the outer shell 140.

The blowing grill 144 may be disposed inside the outer shell 140. The blowing grill 144 may extend along the inner circumference wall of the outer shell 140. For example, the blowing grill 144 may be an annular blowing grill 144 extending along the inner circumference of the first outer shell 140a. The blowing grill 144 may be disposed in the blowing flow path 390. The blowing grill 144 may be disposed between the blowing flow path 390 and the discharge flow path 1000. The blowing grill 144 may be disposed below the second discharge flow path 1000b. The blowing grill 144 may be disposed between the inner shell 130 and the outer shell 140. The rising airflow formed by the blowing fan 350 and bypassing the humidifying device 200 may pass through the blowing grill 144 and flow to the second discharge flow path 1000b.

The outer shell 140 may include a shell opening 146 that is open at the lower side. The shell opening 146 may be formed inside the blowing grill 144. The inner shell 130 may be disposed in the shell opening 146.

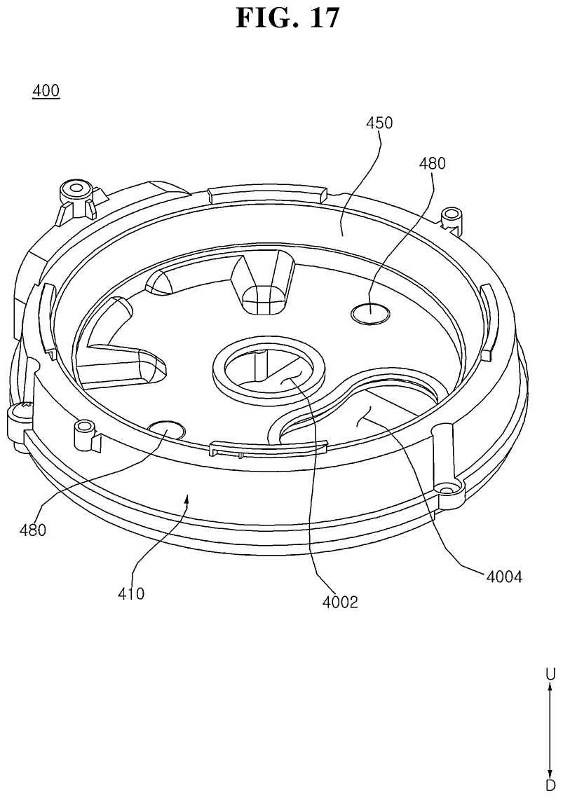

Referring to FIG. 17, the middle tray 400 in certain implementations of humidifier 1 may include a middle housing 410, a light diffuser 450, and a load sensor 480. The middle tray 400 may include the middle housing 410 that forms an external shape of the middle tray 400. The circumference of the middle housing 410 may extend in the up-down direction.

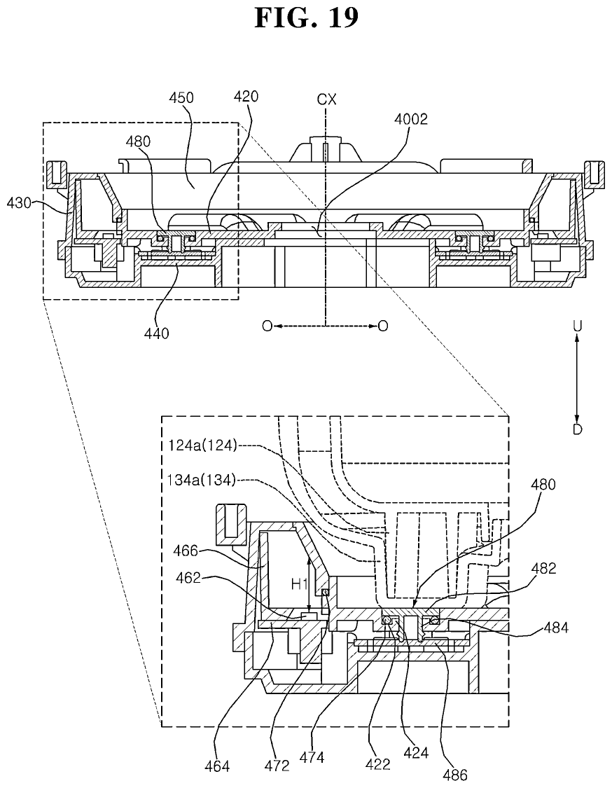

The middle tray 400 may include a light diffuser 450. The light diffuser 450 may output light emitted under the middle tray 400. The light diffuser 450 may diffuse light emitted from a light source 462 described later (see FIG. 19). The light diffuser 450 may diffuse the light emitted from the light source 462 having the form of a point light source to output light substantially in the form of a uniform surface light source. The light diffuser 450 may be referred to as a light-scatter. For example, the light diffuser 450 may be formed of light diffusion resin. The light diffusion resin may refer to a resin having light diffusion characteristics. For example, the light diffusion resin may be polymethyl methacrylate (PMMA). In another example, the light diffusion resin may be acrylonitrile butadiene styrene (ABS). In another example, the light diffuser 450 may be formed of a non-light diffusing material and may include at least one openings through which light passes from light source 460 and is diffused.

The light diffuser 450 may form at least a portion of the inner surface of the peripheral wall of the middle tray 400. The light diffuser 450 may be coupled to the middle housing 410. The light diffuser 450 may transmit light emitted from a light source 462 disposed inside the middle tray.

The middle tray 400 may include a load sensor 480 that detects a load applied from about, such as load from water tank 110. The load sensor 480 may be disposed in the upper surface of the middle tray 400. The load sensor 480 may convert the load into an electrical signal. The load sensor 480 may convert a displacement distance into an electrical signal. A plurality of load sensors 480 may be provided in the middle tray 400. For example, a pair of load sensors 480 may be disposed in the upper surface of the middle tray 400, and may detect the load based on converting the detected displacement in the up-down direction into an electrical signal.

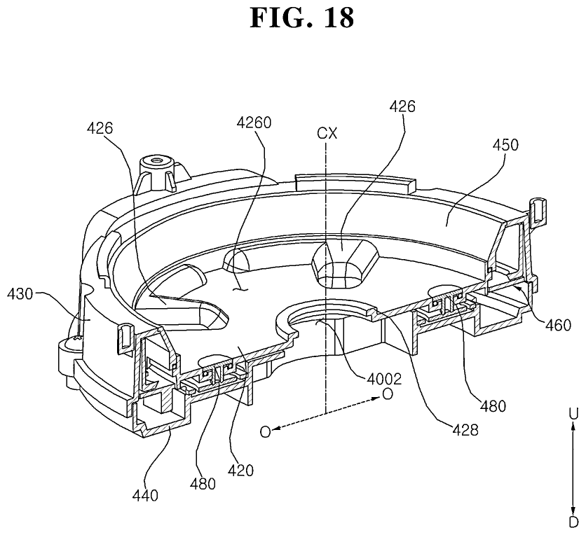

Referring to FIG. 18, the middle tray 400 in certain implementations of humidifier 1 may include a middle cover 430, a middle base 440, a middle plate 420, and a lighting device 460. The middle tray 400 may include the middle cover 430. The middle housing 410 may include the middle cover 430. The middle cover 430 may form at least a portion of the outer circumference of the middle housing 410. The middle cover 430 may be a peripheral wall extending in the up-down direction. The middle cover 430 may be coupled with the light diffuser 450.

The middle tray 400 may include a middle base 440. The middle housing 410 may include the middle base 440. The middle base 440 may form a portion of the lower plate of the middle tray 400. The middle base 440 may be seated on the upper surface of the humidifying device 200. The middle cover 430 may be coupled to the middle base 440. For example, the middle cover 430 may be coupled to the upper side of the middle base 440.

The middle tray 400 may include a middle plate 420. The middle housing 410 may include the middle plate 420. The middle plate 420 may form at least a portion of the upper surface of the middle tray 400. The inner shell 130 may be seated on the middle plate 420. The load of the water tank 110, the water tank housing 120, and/or the inner shell 130 may be transmitted to the middle plate 420. The load sensor 480 may be disposed in the middle plate 420.

The middle plate 420 may include a middle injection hole 4002 through which the supply pipe 210 may be disposed. The middle injection hole 4002 may be a through hole formed in the middle plate 420. The middle injection hole 4002 may be formed at the center of the middle plate 420.

The middle plate 420 may include an injection rib 428 that protrudes upward from the circumference of the middle injection hole 4002. The injection rib 428 may be a boundary forming the middle injection hole 4002. The middle injection hole 4002 may be located inside the injection rib 428. The injection rib 428 may protrude upward from the middle plate 420.

The light diffuser 450 may be coupled to the middle plate 420. The light diffuser 450 may be disposed between the middle cover 430 and the middle plate 420. The middle plate 420 may be disposed above the middle base 440.

The middle plate 420 may include a support seating portion 4260. The second shell support 134b of the inner shell 130 may be seated in the support seating portion 4260. For example, the first shell support 134a of the inner shell 130 may press the load sensor 480. The middle plate 420 may include a protruding platform 426 forming the support seating portion 4260. The protruding platform 426 may protrude upward from the middle plate 420. For example, the support seating portion 4260 may be formed between a pair of protruding platforms 426 that protrude upward. The protruding platform 426 may minimize the horizontal clearance of the second shell support 134b.

The middle tray 400 may include a lighting device 460 that emits light. The lighting device 460 may be disposed inside the middle housing 410. The lighting device 460 may be disposed between the middle cover 430 and the light diffuser 450. For example, the lighting device 460 may be located in the outer side in the horizontal direction than the light diffuser 450, and may be located in the inner side in the horizontal direction than the middle cover 320. The lighting device 460 may be disposed below the light diffuser 450. The lighting device 460 may be disposed above the middle base 440. The light emitted from the lighting device 460 may pass through the light diffuser 450. For example, light emitted from the lighting device may be diffused while passing through the light diffuser 450. The light emitted from the lighting device 460 may pass through the light diffuser 450 and be diffused to pass into the inside of the case 10.

Referring to FIG. 19, the lighting device 460 in certain implementations of humidifier 1 may include a light source 462, a lighting substrate 464, and a lighting bracket 466. The light source 462 may be mounted in the lighting substrate 464. The light source 462 may be disposed below the light diffuser 450 to output light upwards. The horizontal location of the light source 462 may be positioned between the horizontal location of the upper end of the light diffuser 450 and the horizontal location of the lower end. The light source 462 may be located above the horizontal direction than the middle cover 430. For example, the light source 462 may be located radially inside in the horizontal direction than the inner end of the middle cover 430. The light source 462 may be spaced upward from the middle base 440. The light source 462 may be spaced apart from the light diffuser 450. The light diffuser 450 may be spaced upward from the light source 462. For example, the light diffuser may be spaced upward from the light source by a certain height H1.

The lighting substrate 464 may be disposed between the middle cover 430 and the middle plate 420. The lighting substrate 464 may be spaced upward from the middle base 440.

The lighting bracket 466 may fix the lighting substrate 464. The lighting bracket 466 may be connected to the middle cover 430. The lighting bracket 466 may fix the lighting substrate 464 to the middle cover 430. Through the lighting bracket 466, the lighting substrate 464 may be spaced upward from the middle base 440.

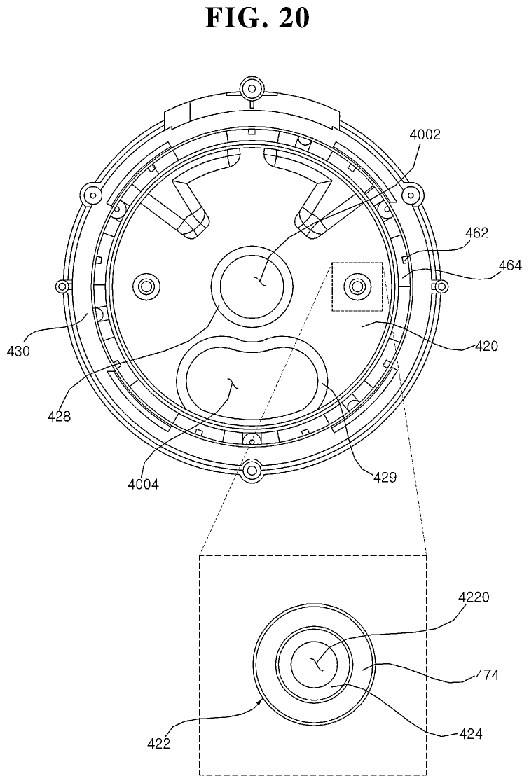

Referring to FIGS. 19 and 20, the load sensor 480 in certain implementations of humidifier 1 may include a contact plate 482, a presser 484, and a sensor substrate 486. The first housing support 124a of the water tank housing 120 may pressurize the first shell support 134a. The first housing support 124a may be located inside the first shell support 134a. The first housing support 124a may transmit the load of the water tank 110 and the water tank housing 120 to the first shell support 134a. The first shell support 134a may pressurize the load sensor 480. The first shell support 134a may be in contact with the contact plate 482. The first shell support 134a may pressurize the contact plate 482, and thus the contact plate 482 may be lowered.

The presser 484 may extend downward from the contact plate 482. The presser 484 may transmit the load pressed on the contact plate 482 to the sensor substrate 486. The presser 484 may pass through the middle plate 420, and contact the sensor substrate 486 disposed inside the middle housing 410.

The middle tray 400 may include a recess 422 in which the load sensor 480 is disposed. The recess 422 may be formed in the middle plate 420. The contact plate 482 may be disposed in the recess 422. The contact plate 482 disposed in the recess 422 may move in the up-down direction. The shape of the recess 422 may correspond to the shape of the contact plate 482. The recess 422 may have a through hole into which the presser 484 is inserted.

The sensor substrate may measure the displacement of the contact plate. The sensor substrate 486 may convert the displacement of the presser 484 into an electrical signal. The sensor substrate 486 may detect the load by measuring the electrical signal. The sensor substrate 486 may detect the level of water stored in the water tank 110 based on the load.

The middle plate 420 may include a sensor stopper 424 that restricts the movement range of the contact plate 482. The sensor stopper 424 may be located below the contact plate 482. The sensor stopper 424 may protrude upward from the recess 422. The sensor stopper 424 may extend along the circumference of the through hole formed in the recess 422. The sensor stopper 424 may be formed in such a manner that the circumference of the through hole formed in the recess 422 protrudes upward. The sensor stopper 424 may prevent the contact plate 482 from moving downward beyond a certain displacement. If the contact plate 482 moves downward beyond a certain displacement, the sensor stopper 424 may be in contact with the lower surface of the contact plate 482, and the contact plate 482 may no longer move downward.

Continuing with FIGS. 19 and 20, the middle tray 400 may include a sealer (or seal) 470. The sealer 470 may include a first sealer (or first seal) 472 disposed between the light diffuser 450 and the middle housing 410. The first sealer 472 may be disposed below the light diffuser 450. The first sealer 472 may be disposed above the middle plate 420. The first sealer 472 may be disposed outside of the circumference of the middle plate 420. The first sealer 472 may extend in the circumferential direction of the middle plate 420. The first sealer 472 may be formed in an annular shape. The first sealer 472 may be in relatively close contact with the light diffuser 450. The first sealer 472 may be in close contact with the middle plate 420. The cross-section of the first sealer 472 may be formed in a substantially circular shape.

The sealer 470 may include a second sealer (or second seal) 474 disposed below the load sensor 480. The second sealer 474 may be disposed between the load sensor 480 and the middle plate 420. The second sealer 474 may be disposed in the recess 422. The second sealer 474 may be disposed outside the sensor stopper 424. For example, the second sealer 474 may be disposed between the peripheral wall forming the recess 422 and the sensor stopper 424. The second sealer 474 may space the contact plate 482 upward from the sensor stopper 424. The second sealer 474 may buffer the load transmitted from the upper side. The second sealer 474 may be in close contact with the contact plate 482. The second sealer 474 may be in close contact with the recess 422. As the load transmitted to the contact plate 482 becomes larger, the second sealer 474 may further come into closer contact with the plate 482 and the recess 422. The second sealer 474 may extend along the circumference of the recess 422. The second sealer 474 may be formed in a substantially annular shape. The second sealer 474 may be formed in a substantially circular cross-section. The diameter of the cross-section of the second sealer 474 may be smaller than the horizontal gap between the peripheral wall forming the recess 422 and the sensor stopper 424. Accordingly, when the second sealer 474 is compressed by a load, the second sealer 474 may be compressed in the vertical direction and stretched in the horizontal direction.

Referring to FIG. 20, the middle plate 420 in certain implementations of humidifier 1 may include a middle outlet 4004 and a discharge rib 429. The middle plate 420 may include the middle outlet 4004 through which humidified air passes. The middle outlet 4004 may be formed in one side of the middle plate 420. The middle outlet 4004 may be a through hole formed in the middle plate 420. The shape of the middle outlet 4004 may correspond to the shape of the humid air outlet 2742. The shell inlet 1304 of the inner shell 130 may be connected to the middle outlet 4004. The protruding rim 138 of the inner shell 130 may correspond to the circumference forming the middle outlet 4004.

The discharge rib 429 may protrude from the middle plate 420. The discharge rib 429 may form the middle discharge hole 4004. The discharge rib 429 may form a boundary forming the middle discharge hole 4004. The discharge rib 429 may extend upward from the circumference of the middle discharge hole 4004. The height at which the discharge rib 429 protrudes from the middle plate 420 may correspond to the height at which the injection rib 428 protrudes from the middle plate 420.

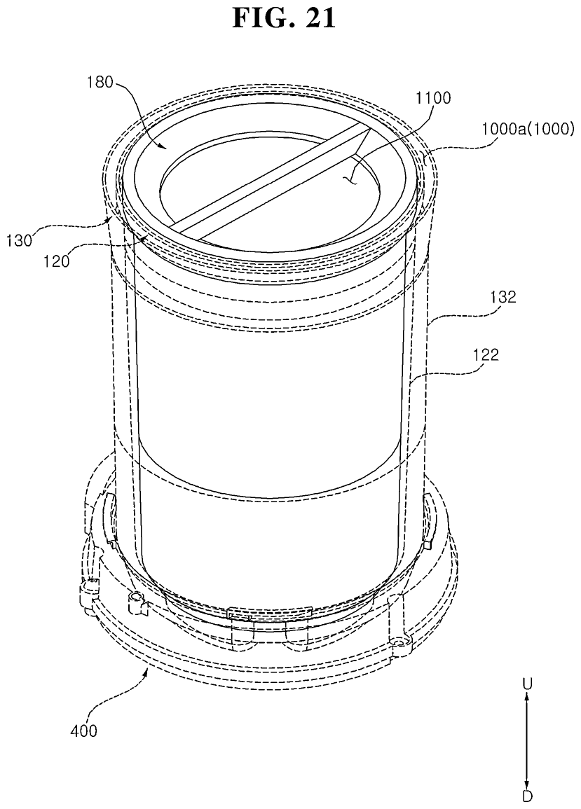

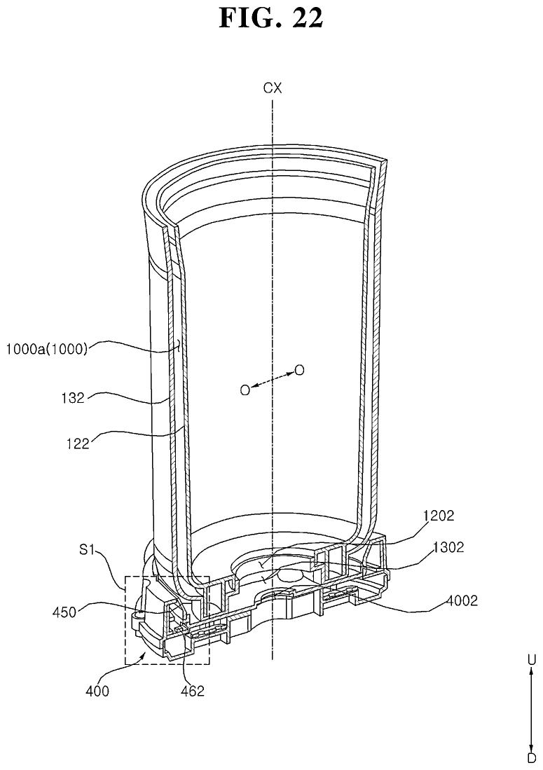

Referring to FIGS. 21 and 22, the inner shell 130 in certain implementations of humidifier 1 may be disposed above the middle tray 400. The inner shell 130 may be disposed above the middle housing 410. The water tank 110, the water tank housing 120, and/or the inner shell 130 may be disposed above the middle tray 400. As previously described, the water tank 110 and/or the water tank housing 120 may be accommodated in the inner shell 130.

As previously described, The inner shell 130 may be spaced outward from the water tank housing 120, and the first discharge flow path 1000a may be formed between the inner shell 130 and the water tank housing 120. The water tank 110 may be accommodated in the water tank housing 120. The water tank 110 may be in relatively close contact with the inside of the water tank housing 120.

The housing injection hole 1202 may be connected to the shell injection hole 1302. The shell injection hole 1302 may be connected to middle injection hole 4002. The housing injection hole 1202, the shell injection hole 1302, and the middle injection hole 4002 may form an injection space. The injection device 114 may be disposed in the injection space. The supply pipe 210 of the humidifying device 200 may protrude upward by penetrating the middle injection hole 4002. The injection device 114 may be mounted in the supply pipe 210.

The light diffuser 450 may face the inner shell 130. For example, the light diffuser 450 may face the lower portion of the inner shell 130. The light source 462 may be disposed below the light diffuser 450. The light diffuser 450 may diffuse the light emitted from the light source 462. The light diffuser 450 may diffuse the light emitted from the light source 462 to illuminate the first discharge flow path 1000a. The inner shell 130 may be formed of a light-transmissive material. For example, the inner shell 130 may be formed transparently so that the first discharge flow path 1000a formed in the inside is visible from the outside. The light diffused by the light diffuser 450 may pass through the transparent inner shell 130 and spread to and pass along the first discharge flow path 1000a. The light may illuminate humidified air flowing through the first discharge flow path 1000a. A user may visually check the humidified air flowing through the first discharge flow path 1000a through the transparent inner shell 130.

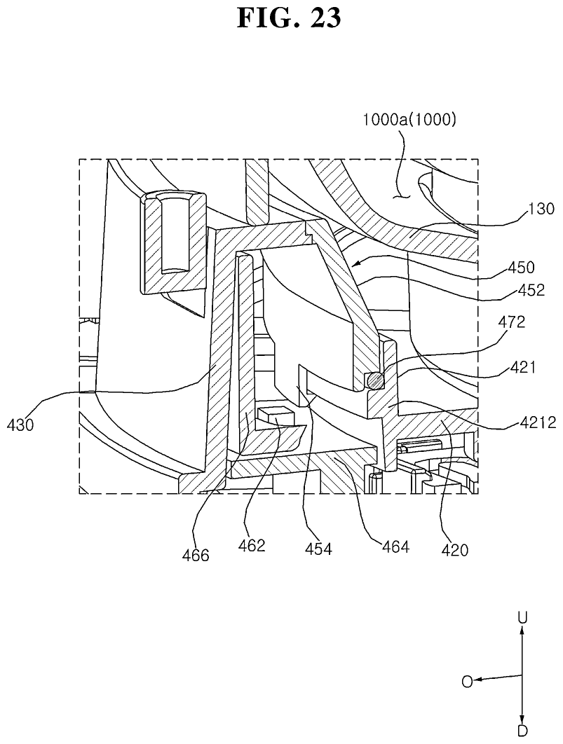

Referring to FIG. 23, the light diffuser 450 in certain implementations of humidifier 1 may be connected to the middle cover 430. The light diffuser 450 and the middle cover 430 may be engaged with each other at a connection portion. The connection portion between the light diffuser 450 and the middle cover 430 may be in close contact. The light diffuser 450 and the middle cover 430 may be glued at the connection portion. The light diffuser 450 and the middle cover 430 may be formed as one body. For example, the light diffuser 450 and the middle cover 430 may be double-shot-injection-molded. Accordingly, a gap may not be formed between the light diffuser 450 and the middle cover 430.

The light diffuser 450 may be coupled to the middle plate 420. The light diffuser 450 may be seated on the middle plate 420. The middle plate 420 may include an inner peripheral wall 421 extending in the up-down direction from the circumference. The inner peripheral wall 421 may be a peripheral wall of the middle cover 430. The middle plate 420 may include a seating rib 4212 that protrudes outward from the inner peripheral wall 421. The light diffuser 450 may be seated on the seating rib 4212. For example, the light diffuser 450 may be disposed in the outside of the inner peripheral wall 421 and seated on the seating rib 4212.

The first sealer 472 may be disposed between the seating rib 4212 and the light diffuser 450. The first sealer 472 may be disposed above the seating rib 4212. The first sealer 472 may be seated on the seating rib 4212. The light diffuser 450 may be disposed above the first sealer 472. The light diffuser 450 may be seated on the first sealer 472 and pressurize the first sealer 472. The first sealer 472 may extend along the circumference of the middle plate 420. The first sealer 472 may seal the gap between the light diffuser 450 and the middle housing 410.

The light diffuser 450 may include a hook 454 coupled to the middle housing 410. The hook 454 may be coupled to the inside of the middle housing 410. The hook 454 may be coupled to the middle plate 420. The hook 454 may be coupled to the seating rib 4212. The hook 454 may extend from the light diffuser 450. The hook 454 may be fastened to the seating rib 4212, and the light diffuser 450 may be fixed to the middle plate 420.

The light diffuser 450 may include a diffuser slope 452 through which light emitted from the light source 462 is transmitted. The diffuser slope 452 may be disposed above the light source 462. The diffuser slope 452 may be inclined toward the center. For example, the diffuser slope 452 may be inclined downward in the center direction. Alternatively, the diffuser slope 452 may be inclined upward in the radial direction.

The diffuser slope 452 may face the center of the case 10. The diffuser slope 452 may face the inner shell 130. The diffuser slope 452 may face the discharge flow path 1000. For example, the diffuser slope 452 may face the first discharge flow path 1000a. The light emitted from the light source 462 may pass through the diffuser slope 452 and diffuse to the first discharge flow path 1000a.

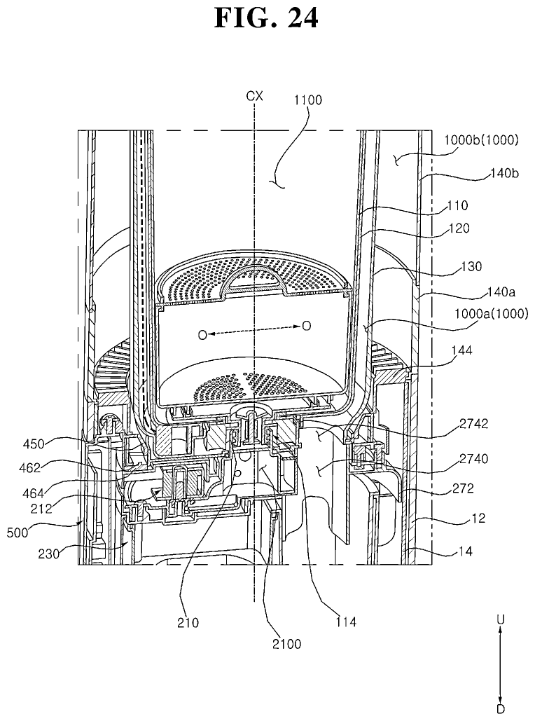

Referring to FIGS. 23 and 24, the lighting device 460 in certain implementations of humidifier 1 may emit light toward the first discharge flow path 1000a. The light source 462 disposed below the discharge flow path 1000 may emit light upward. The light diffuser 450 may diffuse the light emitted from the light source 462. The light diffuser 450 may emit light, which is emitted from a point light source, in the form of a planar light source. The light diffuser 450 may be disposed in the outside of the inner shell 130. The light diffuser 450 may emit light to the inside of the inner shell 130. The emitted light may be transmitted to the first discharge flow path 1000a formed inside the inner shell 130. Through this, the light emitted from the light source 462 may illuminate the humidified air flowing through the discharge flow path 1000.

At least a portion of the water tank housing 120 may be formed of a light-transmissive material. The water tank housing 120 may be formed so that the inside is visible. For example, the water tank housing 120 may be formed to be transparent. For example, the water tank housing 120 may be formed of glass or acrylic. Accordingly, light emitted from the light source 462 may penetrate the water tank housing 120.

The water tank 110 may be formed of a light reflective material, such as a metal. The water tank 110 may be formed so that the inside is not visible. The water tank 110 may be formed of a metal material. For example, the water tank 110 may be formed of stainless steel. The light emitted from the light source 462 may not transmit through the water tank 110. The light emitted from the light source 462 may be reflected by the water tank 110 and directed toward the first discharge flow path 1000a. The light emitted from the light source 462 may be transmitted upward while being reflected. In addition, the light may proceed along the discharge flow path 1000. The light illuminates the humidified air flowing through the discharge passage 1000, and a user may check that the humidified air is flowing inside through the first outer shell 140a which is transparently formed in the outside of the humidifier 1.

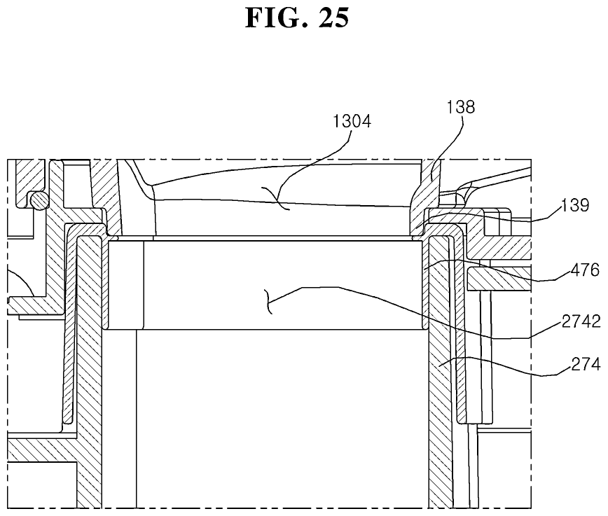

Referring to FIG. 25, the humidifier 1 in certain implementations of humidifier 1 may include a gasket 476 disposed in the discharge pipe 274. The gasket 476 may be placed on the upper end of the discharge pipe 274. The gasket 476 may be disposed between the circumference forming the shell inlet 1304 and the discharge pipe 274. The gasket 476 may be fixed to the discharge pipe 274. The gasket 476 may cover the circumference of the upper end of discharge pipe 274. A protruding rib 138 may be seated on the upper side of the gasket 476. The gasket 476 may be disposed between protruding rib 138 and discharge pipe 274. The inner shell 130 may include an extension rib 139 extending from the lower end of the protruding rib 138. The extension rib 139 may be seated on the gasket 476. The gasket 476 may be in close contact with the extension rib 139. The gasket 476 may be in close contact with the discharge pipe 274. As the gasket 476 is in close contact with the discharge pipe 274 and the extension rib 139, the humidifying device 1 and the inner shell 130 may be in close contact. Accordingly, internal submerging due to leakage of humidified air may be reduced. In addition, water splashed by the vibrator may not leak through a gap formed between the protruding rib and the discharge pipe.

Referring to FIGS. 1 to 25, a humidifier according to one aspect may include a case; a humidifying device which is disposed inside the case, and generates humidified air; and a light source which is disposed inside the case, and emits light, wherein the case includes an inner shell which is disposed above the humidifying device, and in which a first discharge flow path through which the humidified air flows is formed, wherein the light source is disposed outside the inner shell.

According to another aspect, the humidifier may further include a middle tray disposed between the humidifying device and the inner shell, wherein the light source is a plurality of light sources installed inside along a circumference of the middle tray. According to another aspect, the middle tray may include an annular-shaped middle cover which forms an outer circumference, and covers the plurality of light sources; and an annular light diffuser which forms an inner circumference, is made of a light-transmissive material, and covers an inner surface of the plurality of light sources, wherein the plurality of light sources are disposed between the middle cover and the light diffuser.

According to another aspect, the middle cover and the light diffuser are formed as one body. According to another aspect, the middle tray may include an annular light diffuser which is formed of a light-transmissive material, and covers the plurality of light sources; and a middle plate which is disposed in a center of the light diffuser, and on which the inner shell is seated, wherein the light diffuser is coupled to the middle plate.

According to another aspect, the middle plate may include an inner peripheral wall extending upward from a circumference; and a seating rib protruding outward from the inner peripheral wall, wherein the light diffuser is seated on the seating rib. According to another aspect, the humidifier may further include a first sealer disposed between the seating rib and the light diffuser, wherein the first sealer seals a gap between the seating rib and the light diffuser.

According to another aspect, the light diffuser may include a hook fastened to the seating rib. According to another aspect, the middle tray may include a middle base mounted in the humidifying device, wherein the middle cover is disposed above the middle base, and covers an outer circumference of the middle base.

According to another aspect, the humidifier further may include a lighting substrate which is disposed inside the middle tray, and in which the light source is mounted, wherein the middle tray includes a lighting bracket which fixes the lighting substrate to be spaced upward from the middle base. According to another aspect, the humidifying device may include a supply pipe protruding upward to receive water, wherein the middle plate includes a middle injection hole through which the supply pipe passes.

According to another aspect, the middle plate may include an injection rib which extends along a circumference of the middle injection hole and protrudes upward. According to another aspect, the humidifying device may include a discharge pipe having a discharge flow path through which the generated humidified air is discharged, wherein the inner shell includes a shell inlet which is formed in a lower surface, and communicates the discharge flow path with the first discharge flow path.

According to another aspect, the inner shell may include a protruding rib which extends downward from a circumference forming the shell inlet, and corresponds to a circumference of the discharge pipe. According to another aspect, the humidifier may further include a gasket disposed between the discharge pipe and the protruding rib.

According to at least one of the embodiments, the light source may be isolated from the discharge flow path through which humidified air flows by the inner shell, thereby reducing the risk of submerging of the lighting device. According to at least one of the embodiments, the risk of submerging of the lighting device may be reduced due to the middle cover and the light diffuser that cover the light source.

According to at least one of the embodiments, the middle cover and the light diffuser may be defined as one body, so that the amount of moisture penetrating into the lighting device can be reduced and the risk of submerging of the lighting device can be reduced. According to at least one of the embodiments, the inner peripheral wall of the middle plate may define a space in which residual water is temporarily stored, thereby reducing the amount of moisture penetrating into the lighting device and reducing the risk of submerging of the lighting device. According to at least one of the embodiments, the inner peripheral wall of the middle plate covers the inner surface of the light diffuser, thereby reducing the amount of moisture penetrating into the gap between the light diffuser and the inner peripheral wall.

According to at least one of the embodiments, the risk of water damage to the humidifier may be reduced due to the first sealer sealing the gap between the seating rib and the light diffuser. According to at least one of the embodiments, the risk of submerging of the humidifier may be reduced due to the hook that increases the adhesion of the first sealer. According to at least one of the embodiments, the risk of water damage to the lighting device may be reduced due to the lighting substrate spaced upward from the middle base. According to at least one of the embodiments, the risk of water damage to the humidifier may be reduced due to the injection rib protruding from the circumference of the middle injection hole. According to at least one of the embodiments, the gasket may reduce the amount of moisture penetrating into the gap defined between the discharge pipe and the protruding rib, thereby reducing the risk of submerging of the humidifier.

Embodiments disclosed herein may provide a humidifier in which humidified air emits light to an indoor space. Embodiments disclosed herein may further provide a humidifier having an improved durability. Embodiments disclosed herein may furthermore provide a humidifier having a reduced risk of submerging. Embodiments disclosed herein may also provide a humidifier having a reduced risk of short circuit.

In accordance with an aspect, a humidifier may include a case; a humidifying device which is disposed inside the case, and generates humidified air; and a light source which is disposed inside the case, and emits light, wherein the case includes an inner shell which is disposed above the humidifying device, and in which a first discharge flow path through which the humidified air flows is formed, wherein the light source is disposed outside the inner shell, so that the light source may be isolated from the first discharge flow path through which humidified air flows.

The humidifier may further include a middle tray disposed between the humidifying device and the inner shell, wherein the light source is a plurality of light sources installed inside along a circumference of the middle tray. The middle tray may include an annular-shaped middle cover which forms an outer circumference, and covers the plurality of light sources; and an annular light diffuser which forms an inner circumference, is made of a light-transmissive material, and covers an inner surface of the plurality of light sources, wherein the plurality of light sources are disposed between the middle cover and the light diffuser, so that the middle cover and light diffuser can prevent moisture from approaching the light source.

The middle cover and the light diffuser are formed as one body, so that moisture may not move between the middle cover and the light diffuser. The middle tray may include an annular light diffuser which is formed of a light-transmissive material, and covers the plurality of light sources; and a middle plate which is disposed in a center of the light diffuser, and on which the inner shell is seated, wherein the light diffuser is coupled to the middle plate.

The middle plate may include an inner peripheral wall extending upward from a circumference, thereby forming a space where residual water is temporarily stored. The middle plate may include a seating rib protruding outward from the inner peripheral wall, wherein the light diffuser is seated on the seating rib, so that the inner peripheral wall may cover the inner surface of the light diffuser.

The humidifier may further include a first sealer disposed between the seating rib and the light diffuser, wherein the first sealer seals a gap between the seating rib and the light diffuser, thereby reducing the amount of moisture penetrating inside. The light diffuser may include a hook fastened to the seating rib, so that the light diffuser may further pressurize the first sealer.

The middle tray may include a middle base mounted in the humidifying device, wherein the middle cover is disposed above the middle base, and covers an outer circumference of the middle base, thereby reducing the amount of moisture penetrating inside. The humidifier may further include a lighting substrate which is disposed inside the middle tray, and in which the light source is mounted, wherein the middle tray includes a lighting bracket which fixes the lighting substrate to be spaced upward from the middle base, thereby separating the lighting substrate from moisture penetrating inside.

The humidifying device may include a supply pipe protruding upward to receive water, wherein the middle plate includes a middle injection hole through which the supply pipe passes. The middle plate may include an injection rib which extends along a circumference of the middle injection hole and protrudes upward, thereby reducing the amount of moisture penetrating through the middle injection hole.

The humidifying device may include a discharge pipe having a discharge flow path through which the generated humidified air is discharged, wherein the inner shell includes a shell inlet which is formed in a lower surface, and communicates the discharge flow path with the first discharge flow path. The inner shell may include a protruding rib which extends downward from a circumference forming the shell inlet, and corresponds to a circumference of the discharge pipe. The humidifier may further include a gasket disposed between the discharge pipe and the protruding rib, thereby reducing the amount of moisture penetrating into the gap formed between the discharge pipe and the protruding rib.

Certain embodiments or other embodiments of the invention described above are not mutually exclusive or distinct from each other. Any or all elements of the embodiments of the invention described above may be combined or combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments may be devised by those skilled in the art that will fall within the scope of the principles of this disclosure. More particularly, various variations and modifications are possible in the component parts and/or arrangements of the subject combination arrangement within the scope, the drawings and the appended claims. In addition to variations and modifications in the component parts and/or arrangements, alternative uses will also be apparent to those skilled in the art.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A humidifier, comprising:
a case;
a humidifying device which is disposed inside the case and generates humidified air; and
a light source which is disposed inside the case and emits light,
wherein the case includes an inner shell which is disposed above the humidifying device and which defines at least a portion of a discharge flow path through which the humidified air flows, and
wherein the light source is disposed outside of the inner shell.

2. The humidifier of claim 1, further comprising a middle tray disposed between the humidifying device and the inner shell,
wherein the light source includes a plurality of light sources installed along a circumference of the middle tray.

3. The humidifier of claim 2,
wherein the middle tray includes:
an annular-shaped middle cover which forms at least a portion of an outer circumference of the middle tray and covers the plurality of light sources; and
an annular light diffuser which forms at least a portion of an inner circumference of the middle tray, is light-transmissive, and covers the plurality of light sources, and
wherein the plurality of light sources are disposed between the middle cover and the light diffuser.

4. The humidifier of claim 3, wherein the middle cover and the light diffuser are formed as a single body.

5. The humidifier of claim 2, wherein the middle tray includes:
an annular light diffuser which is light-transmissive and covers the plurality of light sources; and
a middle plate which is disposed adjacent to a center of the light diffuser and on which the inner shell is seated,
wherein the light diffuser is coupled to the middle plate.

6. The humidifier of claim 5,
wherein the middle plate includes:
an inner peripheral wall extending upward from a circumference; and
a seating rib protruding outward from the inner peripheral wall, and
wherein the light diffuser is seated on the seating rib.

7. The humidifier of claim 6, further comprising a first seal disposed between the seating rib and the light diffuser,
wherein the first seal is positioned in a gap between the seating rib and the light diffuser.

8. The humidifier of claim 6, wherein the light diffuser includes a hook fastened to the seating rib.

9. The humidifier of claim 3,
wherein the middle tray includes a middle base mounted in the humidifying device, and
wherein the middle cover is disposed above the middle base and covers an outer circumference of the middle base.

10. The humidifier of claim 9, further comprising a lighting substrate which is disposed inside the middle tray and in which the light source is mounted,
wherein the middle tray includes a lighting bracket which fixes the lighting substrate to be spaced upward from the middle base.

11. The humidifier of claim 5,
wherein the humidifying device includes a supply pipe protruding upward to receive water, and
wherein the middle plate includes a middle injection hole through which the supply pipe passes.

12. The humidifier of claim 11,
wherein the middle plate includes an injection rib which extends along a circumference of the middle injection hole and protrudes upward.

13. The humidifier of claim 1,
wherein the humidifying device includes a discharge pipe through which the generated humidified air is discharged, and
wherein the inner shell includes a shell inlet which is formed in a lower surface of the inner shell and communicates the discharge pipe with the discharge flow path.

14. The humidifier of claim 13,
wherein the inner shell includes a protruding rib which extends downward from a circumference of the shell inlet and corresponds to a circumference of the discharge pipe.

15. The humidifier of claim 14, further comprising a gasket disposed between the discharge pipe and the protruding rib.

16. The humidifier of claim 1, further comprising a water tank that supplies water to the humidifying device that is used to form the humified air,
wherein the water tank is positioned radially within the inner shell, and
wherein the discharge flow path is formed the inner shell and the water tank.

17. A humidifier, comprising:
a case that defines a first discharge flow path;
a humidifying device that is provide inside the case below the first flow discharge path and generates humidified air that is output from the humidifier through the first discharge flow path; and
a light source that is positioned above the humidifying device and emits light toward the first discharge flow path.

18. The humidifier of claim 17, further comprising a blower to form an air flow within the case,
wherein a first portion of the air flow from the blower passes into the humidifying device to be humidified,
wherein a second discharge flow path is provided radially outside of the first discharge flow path,
wherein a second portion of the air flow from the blower bypasses the humidifying device and is output through the second discharge flow path, and
wherein the light source does not emit light into the second discharge flow path.

19. The humidifier of claim 17, further comprising a light diffuser that is positioned between the light source and the first flow discharge path.

20. A humidifier, comprising:
a case that includes an inner shell and an outer shell that is disposed outside of the inner shell, the inner shell and the outer shell defining a discharge flow path;
a humidifying device which is positioned inside the case and generates humidified air outputted from the humidifier through the discharge flow path;
a light source that is disposed below the inner and outer shells and that emits light; and
a light diffuser which is transmissive and is positioned between the light source and the discharge flow path.
